(19) United States
(12) Patent Application Publication
(10) Pub. No.: US 2006/0188225 A1
(43) Pub. Date: Aug. 24, 2006

(54) Information storage medium, method and apparatus for reproducing information from the information storage medium and a recording apparatus and recording method for recording video data on the information storage medium

(76) Inventors: Tomoo Yamakage, Yokohama-shi (JP); Takeshi Chujoh, Yokohama-shi (JP); Shinichiro Koto, Kokubunji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/340,598

(22) Filed: Jan. 27, 2006

(30) Foreign Application Priority Data
Jan. 27, 2005 (JP) 2005-020270

(51) Int. Cl. H04N 7/52

(52) U.S. Cl. 386/95

(57) ABSTRACT

In an optical disk, a number of video object units arranged consecutively are recorded. The video object unit contains a navigation pack and video packs following the navigation pack, the navigation pack having address information and a picture category relating to a reference picture, the picture category being determined in compliance with the importance level in respect to the reference picture. A sequence of the packets constitutes a stream of nal units classified into a first group of the nal units contributing to produce the reference picture and a second group of the nil unit not contributing to produce the reference picture. In a nal header of the nal unit, reference item information is described that the nal unit belongs to the first group and contributes to produce the reference picture and a type of the payload, the reference item information indicates the priority of the nal unit.

### CROSS-REFERENCE TO RELATED APPLICATIONS

This application is based upon and claims the benefit of priority from prior Japanese Patent Application No. 2005-020270, filed Jan. 27, 2005, the entire contents of which are incorporated herein by reference.

### BACKGROUND OF THE INVENTION

1. Field of the Invention

This invention relates to an information storage medium, a method and apparatus for reproducing data from the information storage medium and a recording apparatus and method for storing video data on the information storage medium, in particular, to an optical disk stored with video data capable of being played back in a special playable mode, a method and playback apparatus for playing back the video data from the optical disk in the special playback mode and a recording apparatus and method for storing the video data capable of being played back in the special playable mode on the optical disk.

2. Description of the Related Art

Recently, DVD-video discs with high picture resolution and high playback function and video players reproducing such discs have become widely used. The choice of peripheral equipments to reproduce such multi-channel audios is also widely increasing. Home theaters are becoming an accessible reality, and an environment that enables each household to enjoy movies with high picture resolution and high playback function at will is taking place.

In recent years, with the progress of picture compression techniques, higher picture resolution and quality have been required by both users and content providers. Further, in addition to the attainment of the aforementioned high resolution, content providers are expecting reinforcement in content matters, such as the progress in developing colorfulness in a menu or the progress in interactivity in contents including the main title, menu and special privilege footage, in order to provide an appealing content environment to the users.

The standard of the conventional DVD-Video disc described above is, for example, disclosed in Japanese Patent No. 2747268 and corresponding U.S. Pat. No. 5,870,523. As described in these patents, video data is compressed based on the standard of MPEG 1 or MPEG 2 and is stored in a packet data within a video pack. A navigation pack is placed at the head of a Video Object Unit (VOBU), which comprises the video pack, an audio pack and a sub-picture pack, and is defined as the minimum unit for retrieval. In normal playback mode, the Video Object Unit (VOBU) is retrieved by optical pickup, and a video data, audio data as well as sub-picture data within the video pack, audio pack and sub-picture pack are decoded, reproducing the video and audio together. Further, in special playback mode, such as fast forward playback (FF playback) or fast reverse playback (FR playback), an I-picture address provided in a disk search information (DSI) within the navigation pack is used to retrieve an I-picture within the Video Object Unit (VOBU) in order to perform I-picture playback. More specifically, in a video stream of MPEG-2, I- and P-picture end sector addresses of the first to third pictures existing in GOP (Group of Picture) are stored in the disk search information (DSI), and by reproducing the video data relevant to the I- and P-pictures retrieved in accordance with the sector address via the pickup head, a high speed playback is performed.

Recently, an ITU-T Rec. H.264|ISO/IEC 14496-10 (commonly called as MPEG-4 AVC (Advanced Video Coding)) standard has been proposed as the advanced standard of the MPEG2 standard. This H264-AVC (hereinafter simply referred to as MPEG-4 AVC) standard is being employed for the HD DVD standard, which is the next-generation DVD standard. According to this H264-AVC standard, an image with fine picture quality due to high efficiency encoding compression is provided. However, when employing the MPEG-4 AVC standard, the following problem exists in the special playback mode. In MPEG-4 AVC, unlike the case of MPEG-2, the relation between the I-picture, P-picture and B-picture and reference image is not defined, which means that in some cases, even the I-picture and P-picture may not become a reference image whereas even the B-picture may become a reference image. Accordingly, in the special playback mode as in the case of MPEG2, there is a problem that a display sequence after decoding may not be determined by simply referring to the structure of the I-, P- and B-picture. As the Video Elementary Stream in MPEG-4 AVC is a continuous alignment of Nal units, unlike the conventional MPEG-2, there is a problem that a fast forward playback (FF playback) or a fast reverse playback (FR playback) may not be put into practice by reproducing only the I-picture or the I-picture and the P-picture.

### BRIEF SUMMARY OF THE INVENTION

An object of the invention is to provide an optical disk stored with video data capable of being played back in a special playable mode, even if the video data is compressed in accordance with various type of MPEG standards, a method and playback apparatus for playing back the video data from the optical disk in a special playback mode and a recording apparatus and method for storing the video data capable of being played back in a special playable mode on the optical disk.

According to a first aspect of the present invention, there is provided an information storage medium provided with a data recording area, including,

a video object to be produced, which is recorded in the data recording area, the video object comprising a number of video object units, which are arranged consecutively,

each of the video object units comprising a pack sequence containing a navigation pack and video packs following the navigation pack,

the navigation pack having a picture information including address information and a picture category relating to a reference picture, the picture category being determined in compliance with the importance level in respect to the reference picture,

the video pack including a packet, a sequence of the packets constituting a stream of nal units which include a first group of the nal units contributing to produce the reference picture and a second group of the nal unit not contributing to produce the reference picture,

each of the nal units including a nal header and data payload, the nal header including reference item information which describes that the nal unit belong to the first group and contributes to produce the reference picture, and a type of data of the payload, and

the reference item information indicating the priority of the nal unit, which is determined in accordance with the category of the reference picture.

According to a second aspect of the present invention, there is provide a reproduction apparatus for reproducing a video signal from an information storage medium provided with a data recording area which includes;

a video object to be produced, which is recorded in the data recording area, the video object comprising a number of video object units, which are arranged consecutively,

each of the video object units comprising a pack sequence containing a navigation pack and video packs following the navigation pack,

the navigation pack having a picture information including address information and a picture category relating to a reference picture, the picture category being determined in compliance with the importance level in respect to the reference picture,

the video pack including a packet, a sequence of the packets constituting a stream of nal units which include a first group of the nal units contributing to produce the reference picture and a second group of the nal unit not contributing to produce the reference picture,

each of the nal units including a nal header and data payload, the nal header including reference item information which describes that the nal unit belongs to the first group and contributes to produce the reference picture, and a type of data of the payload, and

the reference item information indicating the priority of the nal unit, which is determined in accordance with the category of the reference picture;

the apparatus comprising:

a search unit configured to search for the video object unit in the recording area and to read out the pack sequence in reference to the picture information;

a de-multiplexer configured to demultiplex the video pack from the read out video object unit;

a decoder configured to pick up the nal units from the demultiplexed video packs and decode a combination of the nal units contributing to the production of a reference picture belonging to the category of a high importance level to a reference picture in reference to the priority of the nal unit, and

an output unit to output the video signal of the reference picture.

According to a third aspect of the present invention, there is provided a method of reproducing a video signal from the information storage medium which includes;

a video object to be produced, which is recorded in the data recording area, the video object comprising a number of video object units, which are arranged consecutively,

each of the video object units comprising a pack sequence containing a navigation pack and video packs following the navigation pack,

the navigation pack having a picture information including address information and a picture category relating to a reference picture, the picture category being determined in compliance with the importance level in respect to the reference picture,

the video pack including a packet, a sequence of the packets constituting a stream of nal units which include a first group of the nal units contributing to produce the reference picture and a second group of the nal unit not contributing to produce the reference picture,

each of the nal units including a nal header and data payload, the nal header including reference item information which describes that the nal unit belong to the first group and contributes to produce the reference picture, and a type of data of the payload, and

the reference item information indicating the priority of the nal unit, which is determined in accordance with the category of the reference picture,

the method comprising:

searching for the video object unit in the recording area and to read out the pack sequence in reference to the picture information;

demultiplex the video pack from the read out video object unit;

picking up the nal units from the demultiplexed video packs and decode a combination of the nal units contributing to the production of a reference picture belonging to the category of a high importance level to a reference picture in reference to the priority of the nal unit, and

outputting the video signal of the reference picture.

According to a fourth aspect of the present invention, there is provided a recording apparatus for recording a video object in a recording area of the information storage medium, comprising:

an encode unit configured to encode an input video signal to a stream of nal units each including a nal header and a data payload, allocate the nal units in packets to produce a video elementary stream of packets and allocate the packets in packs, respectively, to produce a MPEG video stream, the nal units being classified into a first group of the nal units contributing to produce a reference picture and a second group of the nal units not contributing to produce the reference picture, the nal unit header including reference item information which describes that the nal unit belong to the first group and contributes to produce the reference picture, and a type of data of the payload, and the reference item information indicating the priority of the nal unit, which is determined in accordance with the category of the reference picture;

a navigation pack producing unit configured to produce navigation packs each having a picture information including address information and a picture category relating to a reference picture, the picture category being determined in compliance with the importance level in respect to the reference picture;

a multiplexer configured to multiplex the navigation packs and video packs and arrange the video packs so as to follow the navigation pack to produce video object units;

a formatter configured to produce a video object including number of video object units successively arranged therein, and

a recording unit configured to record the video object in the recording area of the information storage medium.

According to a fifth aspect of the present invention, there is provided a recording method recording a video object in a recording area of the information storage medium, comprising:

encoding an input video signal to a stream of nal units each including a nal header and a data payload, allocating the nal units in packets to produce a video elementary stream of packets and allocating the packets in packs, respectively, to produce a MPEG video stream, the nal units being classified into a first group of the nal units contributing to produce a reference picture and a second group of the nal units not contributing to produce the reference picture, the nal unit header including reference item information which describes that the nal unit belong to the first group and contributes to produce the reference picture, and a type of data of the payload, and the reference item information indicating the priority of the nal unit, which is determined in accordance with the category of the reference picture;

producing navigation packs each having a picture information including address information and a picture category relating to a reference picture, the picture category being determined in compliance with the importance level in respect to the reference picture;

multiplexing the navigation packs and video packs and arranging the video packs so as to follow the navigation pack to produce video object units;

producing a video object including number of video object units successively arranged therein, and

recording the video object in the recording area of the information storage medium.

According to a sixth aspect of the present invention, there is provided a system comprising:

a transmitter configured to transmit a video data from a server to a client; the video data including

a video object to be produced, which is recorded in the data recording area, the video object comprising a number of video object units, which are arranged consecutively,

each of the video object units comprising a pack sequence containing a navigation pack and video packs following the navigation pack,

the navigation pack having a picture information including address information and a picture category relating to a reference picture, the picture category being determined in compliance with the importance level in respect to the reference picture,

the video pack including a packet, a sequence of the packets constituting a stream of nal units which include a first group of the nal units contributing to produce the reference picture and a second group of the nal unit not contributing to produce the reference picture,

each of the nal units including a nal header and data payload, the nal header including reference item information which describes that the nal unit belongs to the first group and contributes to produce the reference picture, and a type of data of the payload, and

the reference item information indicating the priority of the nal unit, which is determined in accordance with the category of the reference picture.

### BRIEF DESCRIPTION OF THE SEVERAL VIEWS OF THE DRAWING

FIG. 1 is an illustration of a hierarchy structure of an optical disk according to an embodiment of the present invention.

FIG. 2 is an illustration of a hierarchy structure of an HD video manager recording area shown in FIG. 1.

FIG. 3 is an illustration of a description of an HD video manager information management table shown in FIG. 2.

FIG. 4 is an illustration showing a structure of an HD video title set attribution information table shown in FIG. 2.

FIG. 5 is an illustration showing a hierarchy structure of an HD video title set recording area shown in FIG. 1.

FIG. 6 is an illustration of a description of an advanced HD video title set information manager table shown in FIG. 5.

FIG. 7 is an illustration showing a hierarchy structure of an advanced HD video title set recording area shown in FIG. 1.

FIG. 8 is an illustration showing a hierarchy structure of an advanced HD video title set information area shown in FIG. 7.

FIG. 9 is an illustration of a description of an advanced HD video title set information manager table shown in FIG. 7.

FIG. 10 is an illustration showing a hierarchy structure of an advanced HD video title set program chain information table shown in FIG. 8.

FIG. 11 is an illustration showing a structure of an enhanced video object (EVOB), which is recorded in the object area shown in FIG. 1 as well as in FIG. 7.

FIG. 12 is an illustration showing a structure of a video program stream according to MPEG-4 AVC, which is recorded in the enhanced video object (EVOB) shown in FIG. 11.

FIG. 13 is an illustration showing a structure of a video program stream according to MPEG-4 AVC, which is recorded in the enhanced video object (EVOB) shown in FIG. 11 and FIG. 12.

FIG. 14 is a table explaining the relation of nal_ref_idc, which is shown in the NAL header shown in FIG. 12, and picture category.

FIG. 15 is a schematic block diagram of an apparatus, which reproduces a video and audio signal from an optical disk shown in FIG. 1.

FIG. 16 is a block diagram of a video encoder and sub-picture encoder shown in FIG. 15.

FIG. 17 is an illustration showing an MPEG-2 video program stream structure and a video elementary stream structure, which are stored in the enhanced video object unit (EVOBU) shown in FIG. 11.

FIGS. 18A and 18B are illustrations showing the relation of a decoding sequence and display sequence of the video elementary stream shown in FIG. 17.

FIGS. 19A and 19B are illustrations showing the relation between the end address specified within the NAV pack shown in FIG. 17 (e) and the position within EVOBU.

FIG. 20 is an illustration showing the relation of decoding sequence, readout sequence and display sequence of the video elementary stream shown in FIG. 17 when carrying out high-speed playback on a so-called I only.

FIG. 21 is an illustration showing the relation of decoding sequence, readout sequence and display sequence of the video elementary stream shown in FIG. 17 when carrying out high speed playback on a so-called IPP only.

FIG. 22 is an illustration showing the relation of decoding sequence, readout sequence and display sequence of the video elementary stream shown in FIG. 17 when carrying out a so-called IPPP high speed playback.

FIG. 23 is a flow chart showing an aspect of normal playback and high speed playback.

FIG. 24 is a block diagram showing manufacturing equipment for making a primitive plate to make an optical disk shown in FIG. 1.

FIG. 25 is a schematic block diagram further showing a system of another embodiment where the data structure of the present invention can be applied.

### DETAILED DESCRIPTION OF THE INVENTION

Hereinafter, referring to the accompanying drawings, an information storage medium, information reproducing method and an information reproducing apparatus according to an embodiment of the present invention will be explained.

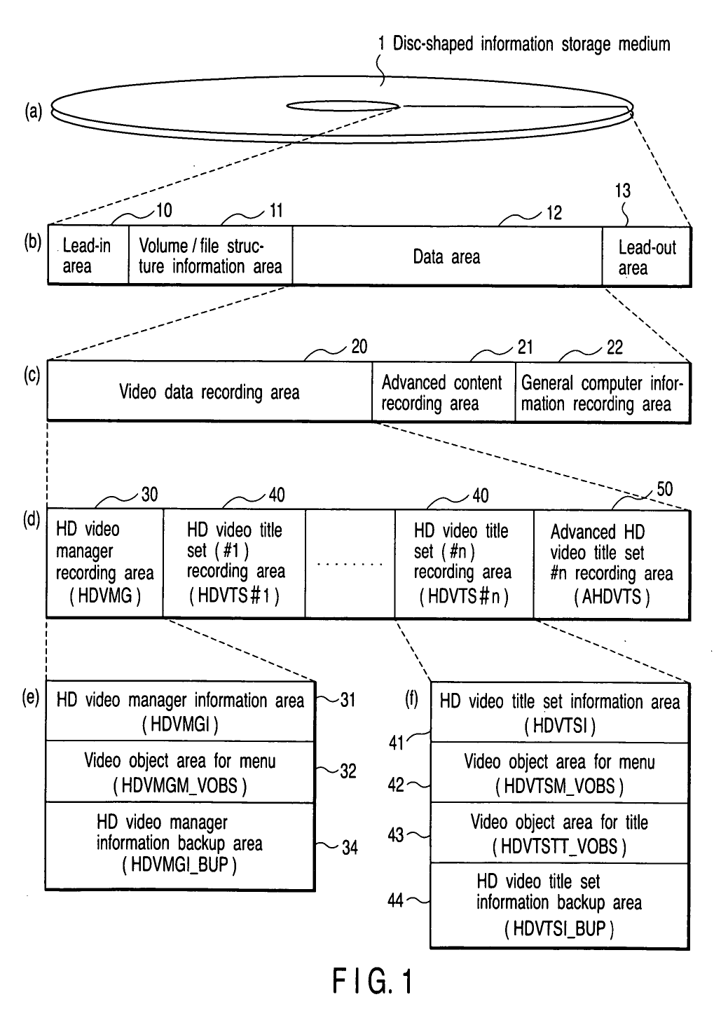

FIGS. 1 (a) to (f) illustrate information contents stored on a disc-shaped information storage medium such as an optical disk according to an embodiment of the present invention. The information storage medium 1 shown in FIG. 1 (a) comprises a High Density or High Definition Digital Versatile Disc (for short, HD_DVD), which enables data to be readout by an optical beam, such by a red light laser having a wavelength of 650 nm or a blue light laser having a wavelength of 405 nm (or less).

As illustrated in FIG. 1 (b), the optical disk 1 has a lead-in area 10 on the side of the inner circumference, and a lead-out area 13 on the side of the outer circumference. The optical disk 1 also has a volume space between the lead-in area 10 and the lead-out area 13, the volume space including a volume/file structure information area 11 and a data area 12. The optical disk 1 employs a bridge structure of ISO9660 and UDF as its file system, and the items pursuant to ISO9660 and UDF are written in the volume/file structure information area 11. Further, in the data area 12, a video data recording area 20 to record a DVD video content (also referred to as a standard content), other video data recording area (an advanced content recording area to record advanced content) 21, and a general computer information recording area 22 are allowed to exist in mixed alignment as shown in FIG. 1 (c).

As illustrated in FIG. 1 (d), the video data recording area 20 comprises an HD video manager (HDVMG: Video Manager which corresponds to High Definition) recording area 30, which stores manager information relevant to the entire HD_DVD video content recorded in the video data recording area 20, HD video title set (HDVTS: Video Title Set corresponding to High Definition: also referred to as standard VTS) recording areas 40, which respectively corresponds to a title and respectively stores its manager information and its video information or data (video object), and an advanced HD video title set (AHDVTS: also referred to as advanced VTS) recording area 50.

As illustrated in FIG. 1 (e), the HD video manager (HDVMG) area 30 includes an HD video manager information (HDVMGI: Video Manager Information corresponding to High Definition) area 31, which indicates manager information relevant to the entire Video data recording area 20, an HD video manager information backup (HDVMGI_BUP) area 34, which, as a backup, stores information equivalent to the HD video manager information area 31, and a Video object area for menu (HDVMGM_VOBS) 32, which stores a top menu indicating the entire Video data recording area 20.

As illustrated in FIG. 1 (f), the HD video title set (HDVTS) recording area 40, which stores a manager information and a video information (video object) per title, comprises an HD video title set information (HDVTSI) area 41, which stores manager information corresponding to a content of the HD video title set recording area 40, an HD video title set information backup (HDVTSI_BUP) area 44, which stores information equivalent to the HD video title set information area 41 as its backup data, a Video object area for menu (HDVTSM_VOBS) 42, which stores information of menu data in units of a video title set, and a Video object area for title (HDVTSTT_VOBS) 43, which stores a video object data (video information of a title) within the video title set.

Each area, 30 and 40, in FIG. 1 respectively has a separate file structure under a file system possessing an ISO9660 and UDF bridge structure. Accordingly, under a root directory, an HVDVD_TS directory and an ADV_OBJ directory are arranged. An information file dealing with High Definition video is stored in the HVDVD_TS directory and an information file dealing with advanced object is stored in the ADV_OBJ directory.

Roughly classified, within the aforementioned HVDVD_TS directory, there is a file group belonging to a menu group used for menu and a file group belonging to a title set group used for title. The file group belonging to a menu group stores a video manager information file (HVI00001.IF0), which possess information to manage the entire disk, its backup file (HVI0001.BUP), and a playback data file of enhanced video object set for menu (HVM00001.EVO˜HVM003.EVO) used as a background screen of the menu.

A file group belonging to a group of title set # n (such as, title set #1 group) stores a video title set information file (HVIxxx01.IF0: x x x=001˜999), which possess information to manage title set # n, its backup (HVIxxx01.BUP: x x x=001˜999), and a playback data file of enhanced video object set for title set # n (HVIxxxyy.EVO: x x x=001˜999, yy=01˜99) used as a title.

Further, a file group belonging to a group of advanced title set stores a video title set information file (HVIA0001.IFO), which possess information to manage advanced title set, its backup file (HVIA0001.BUP), a playback data file of enhanced video object set for advanced title set (HVTAxxyy.EVO: xx=01˜99, yy=01˜99) used as a title, advanced title set time map information file (HVMAxxxx.MAP: xxxx=0001˜9999) and its backup file (HVMAxxxx.BUP: xxxx=0001˜9999, not illustrated) etc.

Furthermore, an ADV_OBJ directory stores a start up information file (STARTUP.XML), a loading information file (LOAD001.XML), a mark up language file (PAGE001.XML), a moving picture data, an animation data, a still picture data file, an audio data file, and a font data file etc. Here, the content of the start up information file is, for example, a moving picture data, animation data, still picture data file, audio data, font data, and further, boot information for data such as a markup language to control reproduction of these data. Further, on a loading information file is recorded a loading information (this can be specified in Markup language/Script language/Style Sheet etc.) and such, which has information relevant to a file to be loaded on a buffer within the reproduction apparatus written.

Here, a markup language, which refers to a language that specifies the character attribute in accordance with a predetermined command, is able to provide type, size and color etc. of a font to a character string as an attribute. In other words, a markup language is a descriptive language, which describes a sentence structure (such as a header and hyperlink) and modified information (such as a font size and forme condition) in a sentence by enclosing a part of a sentence by a special character string called a “tag”.

As a sentence written by using a markup language is done in text file, it is possible for a person to read ordinarily by using a text editor, which, of course, also enables editing. As a common markup language, there is, for example, SGML (Standard Generalized Markup Language), HTML (HyperText Markup Language), which evolved from SGML, and TeX.

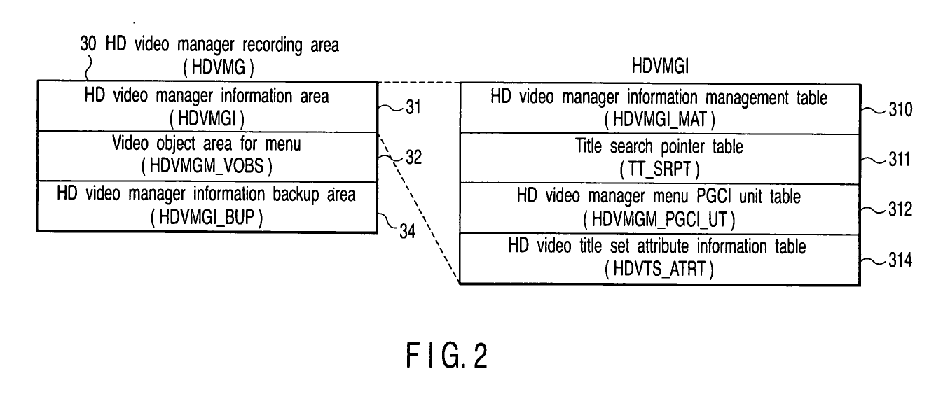

FIG. 2 shows a detailed data structure of the HD video manager information (HDVMGI) area 31 illustrated in FIG. 1 (e). In this area 31, an HD video manager information management table (HDVMGI_MAT) 310, which altogether stores a management information common to the entire HD_DVD video content recorded in the video data recording area 20, is placed at the head of the alignment, followed, in sequence, by a title search pointer table (TT_SRPT) 311, which stores information useful to search each title (each start address of the titles) existing in the HD_DVD video content, an HD video manager menu program chain information unit table (HDVMGM_PGCI_UT) 312, which stores management information of menu data arranged separately per menu description language code to display menu, and an HD video title set attribute information table (HDVTS_ATRT) 314, which altogether stores matters relevant to title set attribute.

With regard to the HD video title set attribute information table (HDVTS_ATRT) 314 illustrated in FIG. 2, if one HD video title set is recorded in the video object area for title (HDVTSTT_VOBS) 43, only an attribute (ATR) of the one HD video title set is recorded, and if a plurality of HD video title sets identified by title numbers #1 to #n are recorded in the video object area for title (HDVTSTT_VOBS) 43, all attribute of the HD video title set identified by the title numbers #1 to #n are recorded per title. As will be explained later, the attribute of the HD video title set is also recorded in the management table 410 of the corresponding HD video title set 40.

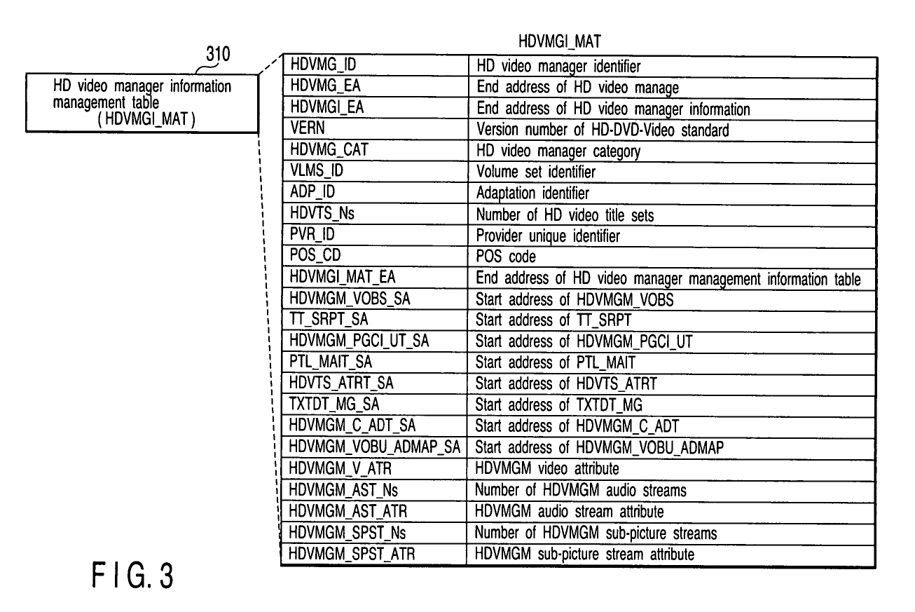

FIG. 3 illustrates a detailed data structure of the HD video manager information management table (HDVMGI_MAT) 310 shown in FIG. 2. As illustrated in FIG. 3, a variety of information is recorded in the HD video manager information management table (HDVMGI_MAT) 310, such as an HD video manager identifier (HDVMG_ID), an end address of HD video manager (HDVMG_EA), an end address of HD video manager information (HDVMGI_EA), a version number of HD-DVD-Video standard (VERN), an HD video manager category (HDVMG_CAT), a volume set identifier (VLMS_ID), an adaptation identifier (ADP_ID), a number of HD video title sets (HDVTS_Ns), a provider unique identifier (PVR_ID), a POS code (POS_CD), an end address of HD video manager management information table (HDVMGI_MAT_EA), a start address of HDVMGM_VOBS (HDVMGM_VOBS_SA), a start address of TT_SRPT (TT_SRPT_SA), a start address of HDVMGM_PGCI_UT (HDVMGM_PGCI_UT_SA), a start address of HDVTS_ATRT (HDVTS_ATRT_SA), HDVMGM video attribute (HDVMGM_V_ATR), a number of HDVMGM audio streams (HDVMGM_AST_Ns), an HDVMGM audio stream attribute (HDVMGM_AST_ATR), a number of HDVMGM sub-picture streams (HDVMGM_SPST_Ns), and an HDVMGM sub-picture stream attribute (HDVMGM_SPST_ATR).

By referring to the start address of HDVTS_ATRT (HDVTS_ATRT_SA), an HD video title set attribute (ATR) identified by the title numbers #1 to #n specified in the HDVTS_ATRT 314 is searched, whereby a player is set in conformity to the attribute (ATR). Further, in reference to the start address of TT_SRPT (TT_SRPT_SA), an HD video title set 40, which is specified by the title number, is searched, whereby the title is reproduced.

In FIG. 3, the HD video manager category (HDVMG_CAT) comprises RMA#1, RMA#2, RMA#3, RMA#4, RMA#5, RMA#6, RMA#7 and RMA#8, which indicate information on whether playback is possible or not for each region corresponding to a group or groups of the countries of the world in predetermined regions, and an application type indicating the VMG category. Here, the application type bears the following values;

Application Type=0000b: including standard VTS only
=0001b: including advanced VTS only
=0010b: including both the advanced VTS and the standard VTS

That is to say, when the application type is “0000b”, this information storage medium is an information storage medium (content type 1 disk) which includes only the standard VTS, when the application type is “0001b”, this information storage medium is an information storage medium (content type 2 disk) which includes only the advanced VTS, and when the application type is “0010b”, this information storage medium is an information storage medium (content type 2 disk) which includes both the standard VTS and the advanced VTS.

The title search pointer table (TT_SRPT) 311 illustrated in FIG. 2 comprises title search pointer table information (TT_SRPTI) and title search pointer (TT_SRP) information. In one title search pointer (TT_SRP) information is recorded a variety of information including a title playback type (TT_PB_TY), which relates to a title indicated by the search pointer, number of angle (AGL_Ns), number of Part_of_Title (PTT) (PTT_Ns), an HDVTS number (HDVTSN), an HDVTS title number (HDVTS_TTN), and a start address of the present HDVTS (HDVTS_SA). Further, in one title search pointer (TT_SRP) information 311b is recorded a variety of information including a title playback type (TT_PB_TY), which relates to the title indicated by the search pointer, number of angle (AGL_Ns), number of Part_of_Title (PTT) (PTT_Ns), a Parental_ID_Field for title (TT_PTL_ID_FLD) information, an HDVTS number (HDVTSN), an HDVTS title number (HDVTS_TTN), and a start address of the present HDVTS (HDVTS_SA).

In the HD video manager menu PGCI unit table (HDVMGM_PGCI_UT) 312 illustrated in FIG. 3 is recorded, for example, an HD video manager menu program chain information unit table information (HDVMGM_PGCI_UTI) and an HD video manager menu language unit (HDVMGM_LU) or HD video manager menu language units (HDVMGM_LU). The menu PGCI unit table (HDVMGM_PGCI_UT) 312 further includes a video manager menu language unit search pointer (HDVMGM_LU_SRP) or pointers (HDVMGM_LU_SRP#n) each searching the language unit (HDVMGM_LU). A common management information within the HD video manager menu PGCI unit table (HDVMGM_PGCI_UT) 312 is recorded in the table information (HDVMGM_PGCI_UTI), and each of the HD video manager menu language units (HDVMGM_LU) is grouped for a menu description language displaying a menu which is specified by a menu description language code described in the table information (HDVMGM_PGCI_UTI). A menu of the video object area for menu (HDVMGM_VOBS) 32 is reproduced in reference to the HD video manager menu program chain information unit table information (HDMGM_PGCI_UTI) and the HD video manager menu language unit (HDVMGM_LU) which is searched by the language unit search pointer (HDVMGM_LU_SRP).

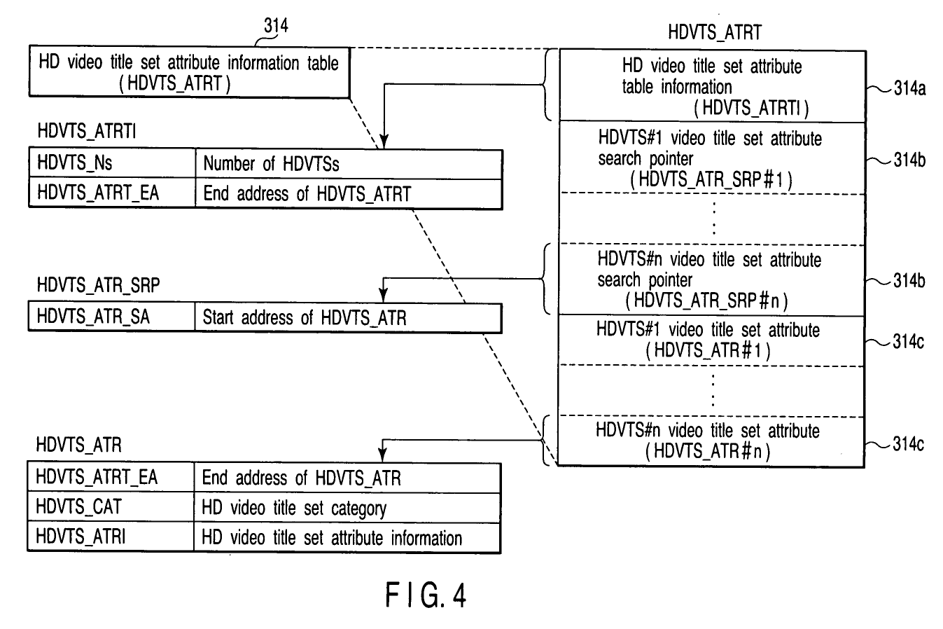

FIG. 4 illustrates a data structure of the HD video title set attribute information table (HDVTS_ATRT) 314 illustrated in FIG. 3. As shown in FIG. 4, this HD video title set attribute information table 314 comprises an HD video title set attribute table information (HDVTS_ATRTI) 314a, which possess information of a number of HDVTS (HDVTS_Ns) and an end address of HDVTS_ATRT (HDVTS_ATRT_EA); an HDVTS video title set attribute search pointer (HDVTS_ATRT_SRP) 314b, in which a start address of HDVTS_ATR (HDVTS_ATR_SA) information is recorded; and an HDVTS video title set attribute (HDVTS_ATR) 314c, which possess each information of an end address of HDVTS_ATR (HDVTS_ATR_EA), an HD video title set category (HDVTS_CAT) and an HD video title set attribute information (HDVTS_ATRI). A particular video title set attribute can be located from the HDVTS video title set attribute (HDVTS_ATR) 314c by using the HDVTS video title set attribute search pointer (HDVTS_ATRT_SRP) 314b.

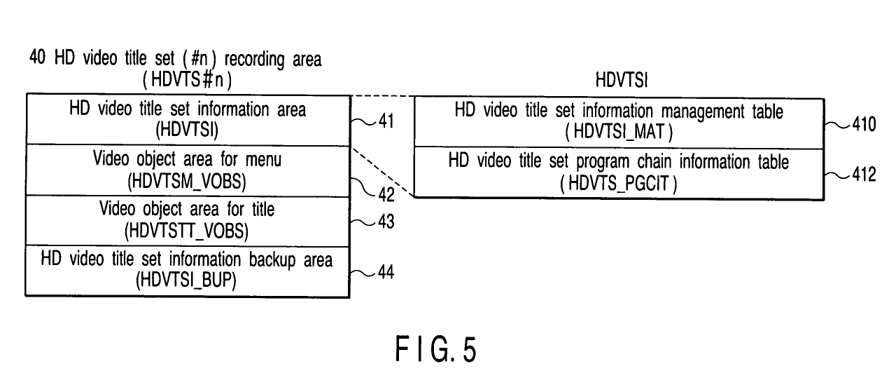

FIG. 5 illustrates a data structure of one HD video title set information (HDVTSI) 41 recorded in each HD video title set (HDVTS#n) recording area. This HD video title set information 41 is, for example, recorded altogether in the HVI00101.IFO and/or HVIA0001.IFO file (or in a separate file within a DVD video content called VTS00100.IFO).

The HD video title set information (HDVTSI) area 41 illustrated in FIG. 1 (f) includes an HD video title set information management table (HDVTSI_MAT) 410 and an HD video title set program chain information table (HDVTS_PGCIT) 412 as illustrated in FIG. 5. The HD video title set program chain information table (HDVTS_PGCIT) contains search pointers, which assign a playback sequence of the program chains, whereby EVOBUs (Enhanced Video Object Units), i.e. the playback objects, are reproduced in sequence at this search pointers, and a moving picture image is reproduced, as will be explained later.

In the HD video title set information management table (HDVTSI_MAT) 410 is recorded a management information common to the relevant video title set (VTS). By placing this common management information (HDVTSI_MAT) in the first area of the HD video title set information (HDVTSI) area 41, before starting reproduction of object, the common management information within the video title set is read, which enables simplified playback control processing and reduced control processing time of the reproducing apparatus.

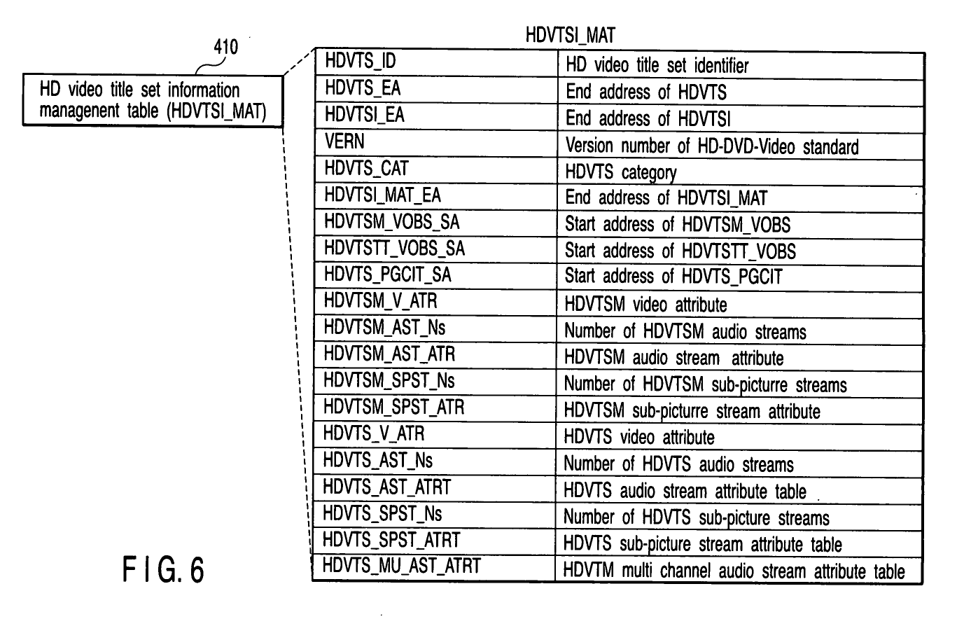

FIG. 6 illustrates a data structure of the HD video title set information management table (HDVTSI_MAT) to be recorded in the HD video title set information (HDVTSI). As show in FIG. 6, in the HD video title set information management table (HDVTSI_MAT) 410 is recorded, an HD video title set identifier (HDVTS_ID), an end address of HDVTS (HDVTS_EA), an end address of HDVTSI (HDVTSI_EA), a version number of HD-DVD-Video standard (VERN), an HDVTS category (HDVTS_CAT), an end address of HDVTSI_MAT (HDVTSI_MAT_EA), a start address of HDVTSM_VOBS (HDVTSM_VOBS_SA), a start address of HDVTSTT_VOBS (HDVTSTT_VOBS_SA), a start address of HDVTS_PGCIT (HDVTSM_PGCIT_SA), a number of HDVTSM audio streams (HDVTSM_AST_Ns), an HDVTSM audio stream attribute (HDVTSM_AST_ATR), a number of HDVTSM sub-picture streams (HDVTSM_SPST_Ns), and an HDVTSM sub-picture stream attribute (HDVTSM_SPST_ATR). Further, various information is recorded in the HD video title set information management table (HDVTSI_MAT) 410, such as a video attribute as an attribute of the relevant HDVTS video title set (HDVTS_V_ATR), a number of HDVTS audio streams (HDVTS_AST_Ns), an HDVTS audio stream attribute table (HDVTS_AST_ATRT), a number of HDVTS sub-picture streams (HDVTS_SPST_Ns), an HDVTS sub-picture stream attribute table (HDVTS_SPST_ATRT), and an HDVTS multi-channel audio stream attribute table (HDVTS_MU_AST_ATRT).

The relevant HDVTS attribute is also written in the HD video title set attribute table (HDVTS_ATRT) 314 within the HDVMG 30 as an attribute per title as mentioned earlier. In the video attribute (HDVTS_V_ATR), a video compressed mode is written as the video attribute, such that the compressed mode of the moving picture complies with MPEG1 (00b), complies with MPEG2 (01b) or complies with MPEG4-AVC (11b). When compliant with MPEG 2 (01b) is written as this video compressed mode, a video data stream which is encoded in accordance with MPEG 2 is packetized in the plurality of packets as explained later, and these packets are recorded in the video object area for title (HDVTST_VOBS) 43. Further, when compliant with MPEG 4 (11b) is written as this video compressed mode, a video data stream which is encoded in accordance with MPEG 4-AVC is also packetized in the plurality of packets, and these packets are recorded in the video object area for title (HDVTST_VOBS) 43. Accordingly, in principle, a video data stream possessing equivalent attribute is recorded in one video object area for title (HDVTST_VOBS) 43. As for the video attribute, aspect ratio and display mode etc. are written in addition to the video compressed mode.

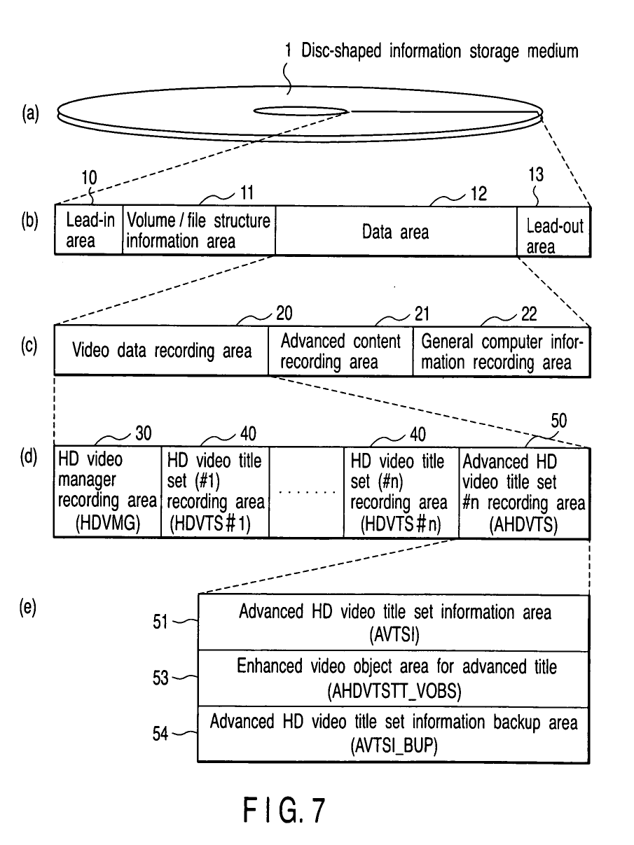

The advanced HD video title set (AHDVTS: advanced VTS) illustrated in FIG. 1 (d) will be explained with reference to FIG. 7 (a) to (d). In FIG. 7 (a) to (e), explanations on structures illustrated in FIG. 7 (a) to (d) will be omitted as they are equivalent to those illustrated in FIG. 1 (a) to (d). The advanced HD video title set (AHDVTS: advanced VTS) is a video object specialized to be referred from a Markup language, which is one of the aforementioned advanced content.

As illustrated in FIG. 7 (e), the advanced HD video title set (AHDVTS) recording area 50 comprises an advanced HD video title set information (AVTSI) area 51, in which a management information with respect to all contents recorded in the advanced HD video title set recording area 50, an advanced HD video title set information backup area (AHDVTSI_BUP) 54, in which the same information as the advance HD video title set information area 51 is recorded as its backup data, and a video object area for advanced title (AHDVTSTT_VOBS) 53, in which a video object (video information of the title) data within the advanced HD video title set is recorded.

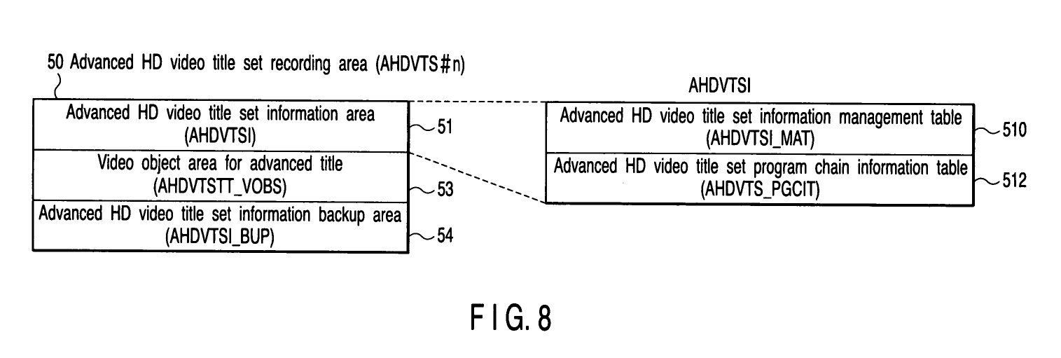

FIG. 8 illustrates a data structure of the advanced HD video title set information recorded in the advanced HD video title set recording area. Recorded altogether in the HVIA0001.IFO (or VTSA0100.IFO not shown in the figures) file as explained earlier, in the advanced HD video title set information (AHDVTSI) area 51 illustrated in FIG. 7E an advanced HD video title set information manager table (AHDVTSI_MAT) 510 and an advanced HD video title set program chain information table (AHDVTS_PGCIT) 512 are recorded as shown in FIG. 8.

In the advanced HD video title set information manager table (AHDVTSI_MAT) 510, a management information common to the relevant video title set is recorded. By placing this common management information (AHDVTSI) in the first area (management information group) within the advanced HD video title set information (AHDVTSI) area 51, the common management information within the video title set is read, which enables simplified playback control and reduced control time of the information reproducing apparatus.

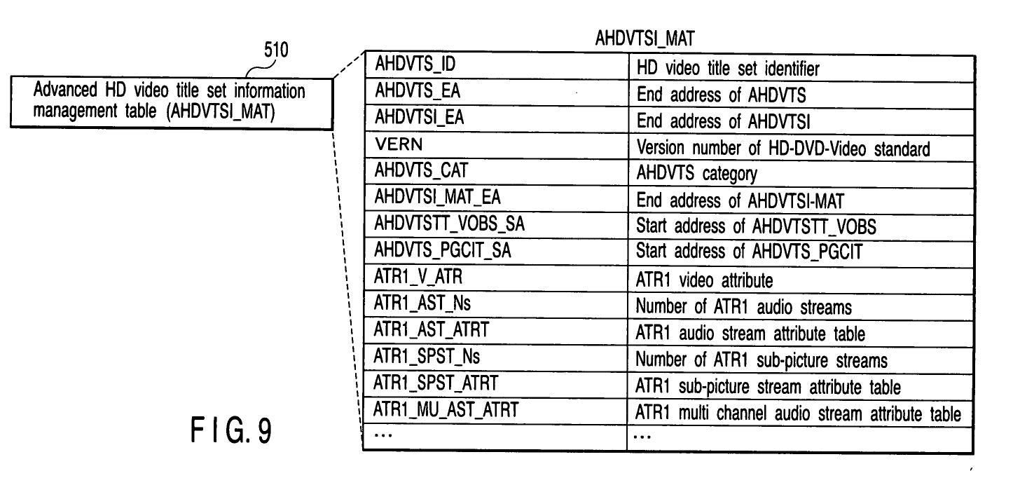

FIG. 9 shows a data structure of an advanced HD video title set information management table (AHDVTSI_MAT) recorded in the advanced HD video title set information (AHDVTSI) and a recorded content of the category information (AHDVTS_CAT) stored within this management table. The advanced HD video title set information management table (AHDVTSI_MAT) 510 is organized to store the following information as common management information within the video title set. More specifically, as illustrated in FIG. 9, the advanced HD video title set information management table (AHDVTSI_MAT) 510 is composed to store a variety of information, such as an advanced HD video title set identifier (AHDVTS_ID), an end address of advanced HDVTS (AHDVTS_EA), an end address of advanced HDVTSI (AHDVTSI_EA), a version number of HD-DVD-Video standard (VERN), an AHDVTS category (AHDVTS_CAT), an end address of AHDVTSI_MAT (AHDVTSI_MAT_EA), a start address of AHDVTSTT_VOBS (AHDVTSTT_VOBS_SA), a start address of AHDVTS_PGCIT (AHDVTS_PGCIT_SA), a video attribute of a video object possessing attribute information 1 (ATR1) (ATR1_V_ATR), a number of audio streams of a video object possessing attribute information 1 (ATR1) (ATR1_AST_Ns), an audio stream attribute table of a video object possessing attribute information 1 (ATR1) (ATR1_AST_ATRT), a number of ATR1 sub-picture streams of a video object possessing attribute information 1 (ATR1) (ATR1_SPST_Ns), a sub-picture stream attribute table of a video object possessing attribute information 1 (ATR1) (ATR1_SPST_ATRT), and a multi-channel audio stream attribute table of a video object possessing attribute information 1 (ATR1) (ATR1_MU_AST_ATRT) (attribute information 2, attribute information 3 to follow).

For the video attribute (ATR1_V_ATR), likewise the video attribute (ATR1_V_ATR) of the HD video title set information management table (HDVTSI_MAT) 410, a video compressed mode is written as a video attribute such that the video compressed mode of the video stream is compliant with MPEG1 (00b), compliant with MPEG2 (01b) or compliant with MPEG4-AVC (11b). When compliant with MPEG 2 (01b) is written as this video compressed mode, a video data stream which is encoded in accordance with MPEG 2 is packetized in the plurality of packets as will be explained later, and these packets are recorded in the video object area for title (HDVTST_VOBS) 53. Further, when compliant with MPEG 4 (11b) is written as this video compressed mode, a video data stream which is encoded in accordance with MPEG 4 is packetized in the plurality of packets, and these packets are recorded in the video object area for advanced title (AHDVTSTT_VOBS) 53. Accordingly, in one video object area for advanced title (HDVTST_VOBS) 53, in principle, a video data stream possessing equivalent attribute will be recorded. As for the video attribute, aspect ratio and display mode etc. are written in addition to the video compressed mode.

In addition, among the information stored in the management table (AHDVTSI_MAT) illustrated in FIG. 9, the start address of HDVTSM_VOBS, which existed in the standard VTS, does not have to exist (or could be decided as a reserved area) since an HDVTSM_VOBS does not exist in the advanced VTS.

Here, the information indicating the category of advanced VTS (AHDVTS_CAT), which is stored in the advanced HD video title set information management table (AHDVTSI_MAT) 510 illustrated in FIG. 9 is defined as follows:

AHDVTS_CAT=0000b: does not identify the AHDVTS category

AHDVTS_CAT=0001b: reserved

AHDVTS_CAT=0010b: Advanced VTS involving advanced content

AHDVTS_CAT=0011b: Advanced VTS not involving advanced content

AHDVTS_CAT=Others: reserved

Here, “Advanced VTS involving advanced content”, which a category is indicated by “AHDVTS_CAT=0010b”, basically indicates an advanced VTS composed by accompanying a Markup language. In fact, in this category, the content provider assumes an “advanced VTS controlled by a Markup language”, which reproduction is allowed only in compliance with the Markup language control, but not by the advanced VTS alone. For example, if the content provider writes a Markup language that allows playback of the advanced VTS in a certain zone only under certain conditions, and the advanced VTS is allowed to perform reproduction on its own, this certain zone will be allowed to reproduce even under conditions other that the certain conditions. The advanced VTS in the “AHDVTS_CAT=0010b” category prohibits this type of reproduction.

The “Advanced VTS not involving advanced content”, which a category is indicated by “AHDVTS_CAT=0011b”, basically indicates an advanced VTS, which is able to perform reproduction by the advanced VTS alone, without accompanying the Markup language.

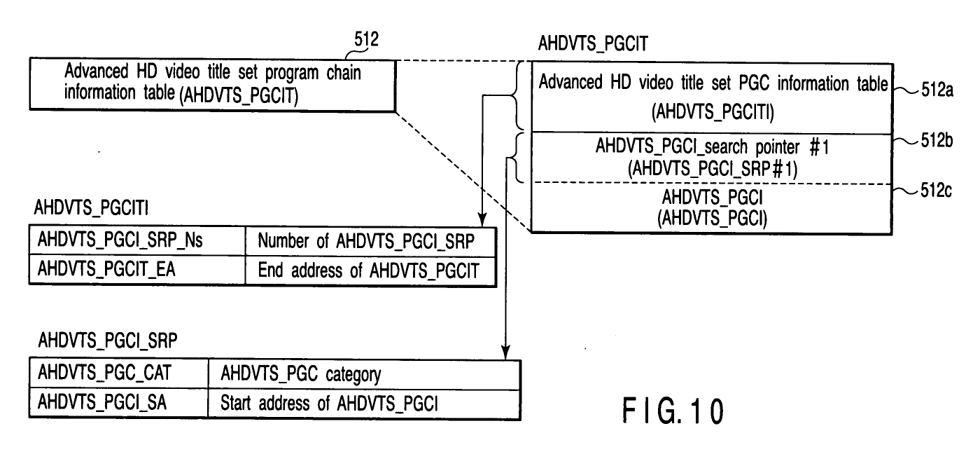

FIG. 10 illustrates a data structure of an advanced HD video title set program chain information table (AHDVTS_PGCIT) to be recorded in the advanced HD video title set information (AHDVTSI). As illustrated in FIG. 10, in the advanced HD video title set program chain information table (AHDVTS_PGCIT) 512 is recorded an information of an advanced HD video title set PGCI information table (AHDVTS_PGCITI) 512a, which includes information of a number of AHDVTS_PGCI SRP (AHDVTS_PGCI_SRP_Ns) and an end address of AHDVTS_PGCIT (AHDVTS_PGCIT_EA). Further, in the AHDVTS_PGCI search pointer (AHDVTS_PGCI_SRP) 512b is recorded an information of the aforementioned AHDVTS_PGC category (AHDVTS_PGC_CAT) along with a start address of AHDVTS_PGCI (AHDVTS_PGCI_SA). Accordingly, a search pointer, which determines a playback sequence, is retrieved in reference to the starting address of AHDVTS_PGCI (AHDVTS_PGCI_SA), whereby an EVOBU (Enhanced Video Object Unit), explained later, within the object is reproduced by this search pointer.

Here, within the advanced VTS, since only one PGC exists, the value of AHDVTS_PGCI_SRP_Ns is fixed as 1, and one search pointer (AHDVTS_PGCI_SRP) 512b and one PGC information (AHDVTS_PGCI) 512c exist.

With regard to the structure of the optical disk shown in FIG. 7, an advanced HD video title set (AHDVTS) 50 could be provided alone in the optical disk video data recording area. If an HD video title set recording area (HDVTS) 40 is not provided, obviously, an HD video manager recording area (HDVMG) 30 will not be provided.

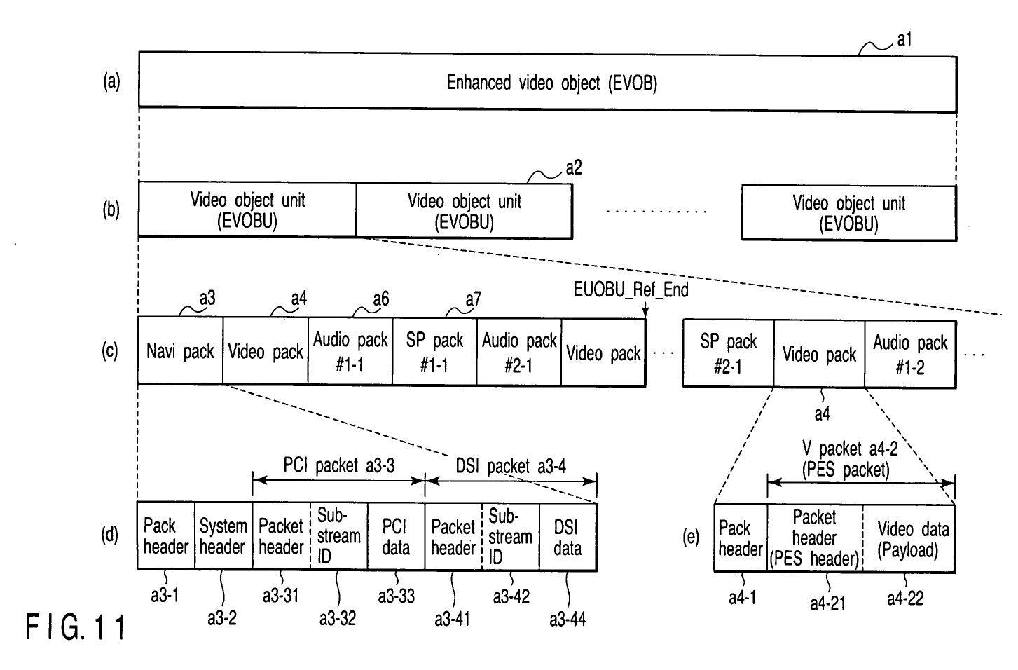

As an HD_DVD video content, an enhanced video object data EVOB (Enhanced Video Object) a1 is provided with a structure illustrated in FIG. 11 (a) to (e). This EVOB (Enhanced Video Object) a1 is recorded in the video object area for title (HDVTSTT_VOBS) 43 of the standard video title set (HDVTS) 40 shown in FIG. 5 or in the video object area for advanced HD title (AHDVTSTT_VOBS) 53 of the advanced HD video title set recording area (AHDVTS) 50. Further, an enhanced video object data EVOB (Enhanced Video Object) a1 bearing the structure illustrated in FIG. 7 (a) is also recorded in the video object area for menu (HDVMGM_VOBS) 32 and the video object area for menu (HDVTSM_VOBS) 42. The object data recoded in the video object area for menu (HDVMGM_VOBS) 32 and the video object area for menu (HDVTSM_VOBS) 42 is not restricted to a moving picture and could also be a still image or picture.

This EVOB (Enhanced Video Object) a1 is composed of a group of EVOBUs (Enhanced Video Object Units), each of which is the reproduction unit as shown in FIG. 11 (b), and a navigation pack (NV_PCK) a3 is placed at the head of each EVOBU as illustrated in FIG. 11 (c). Further, as illustrated in FIG. 11 (c), a video data, an audio data and a sub-picture data are respectively received in a video pack (V_PCK) a4, an audio pack (A_PCK) a 6 and a sub-picture pack (SP_PCK) a7. The video packs (V_PCK) a4, the audio packs (A_PCK) a 6 and the sub-picture packs (SP_PCK) a7 are multiplexed in the EVOBU a2.

As illustrated in FIG. 11 (d), a pack header a3-1 and a system header a3-2 are placed at the head of the navigation pack (NV_PCK) a3, and this system header a3-2 is followed by a PCI (Presentation Control Information) packet a3-3 and a DSI (Data Search Information) packet a3-4. A packet header a3-31 and a sub-stream ID a3-32 are provided in the PCI packet a3-3, and this sub-stream ID (Identifier) a3-32 is followed by a PCI data a3-33. The DSI packet a3-4 is provided with a packet header a3-41 and a sub-stream ID a3-42, which is followed by a DSI data a3-43. In the packet header a3-31 of the PCI packet a3-3, a stream ID which describes that the relevant packet belongs to a private stream is written, and in the sub-stream ID a3-32 of the PCI packet a3-3, a sub-stream ID which describes that the PCI (Presentation Control Information) data of the relevant packet belongs to a PCI stream presupposing a private stream is written. Equivalently, in the packet header a3-41 of the DSI packet a3-4, a stream ID which describes that the relevant packet belongs to a private stream is written, and in the sub-stream ID a3-42 of the DSI packet a3-4, a sub-stream stream ID which describes that a DSI (Disk Search Information) data of the relevant packet belongs to a DSI stream presupposing a private stream is written. Accordingly, by reference to the stream ID of the packet headers a3-31 and a3-41 and the sub-stream stream IDs a3-32 and a3-42, PCI packet a3-3 and DSI packet a3-4 could be distinguished from other packets.

The PCI (Presentation Control Information) data a3-33 is a navigation data to control the presentation of the video object unit VOBU a2, to which the aforementioned navigation pack a3 belongs. The DSI (Disk Search Information) data a3-44 is a navigation data to search and to carry out a seamless playback of the video object unit VOBU a2. The DSI data a3-44 includes seamless playback information to carry out a seamless playback of the video object unit VOBU a2 to which the relevant navigation pack a3 belongs, and search information (EVOBU_SRI) to search for a video object unit VOBU a2 other than the relevant video object unit VOBU a2.

In the search information (EVOBU_SRI), there is written a plurality of VOBU start addresses arranged in the fast forward (FF) direction and the fast reverse (FR) direction on the basis of the video object unit VOBU a2, in which the relevant search information (EVOBU_SRI) belongs. Accordingly, by reference to the search information (EVOBU_SRI) upon fast forward (FF) playback and fast reverse (FR) playback, the VOBU can be searched in sequence. Further, the DSI data a3-44 includes DSI general information in which address information (EVOBU_{—}1STREF_EA, EVOBU_{—}2NDREF_EA, EVOBU_{—}3RDREF_EA) is described for carrying out the special playback mode in accordance with the video compressed mode as explained later. Thus, the special playback is performed by utilizing this DSI address information (EVOBU_{—}1STREF_EA, EVOBU_{—}2NDREF_EA, EVOBU_{—}3RDREF_EA).

The video pack a4 is provided with a pack header a4-1 followed by one video packet a4-2 as illustrated in FIG. 11 (e). The video packet a4-2 is provided with a packet header a4-21 and a video data a4-22. The video data a4-22 stores an MPEG video data compressed in compliance with the video compressed mode. That is, if the video attribute (HDVTS_V_ATR, ATR1_V_ATR) is described as conforming to MPEG2 (01b) for the video compressed mode, a video data compressed by MPEG-2 is stored in the video data a4-22, and if the video attribute (HDVTS_V_ATR, ATR1_V_ATR) is described as conforming to MPEG4 (11b) for the video compressed mode, a video data compressed by MPEG-4 is stored in the video data a4-22.

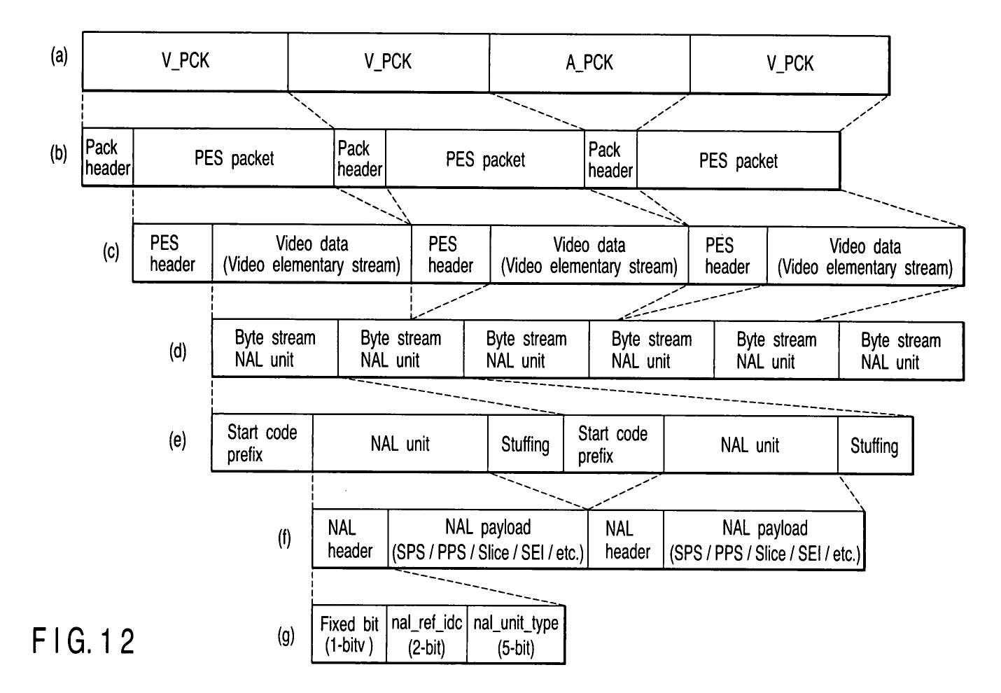

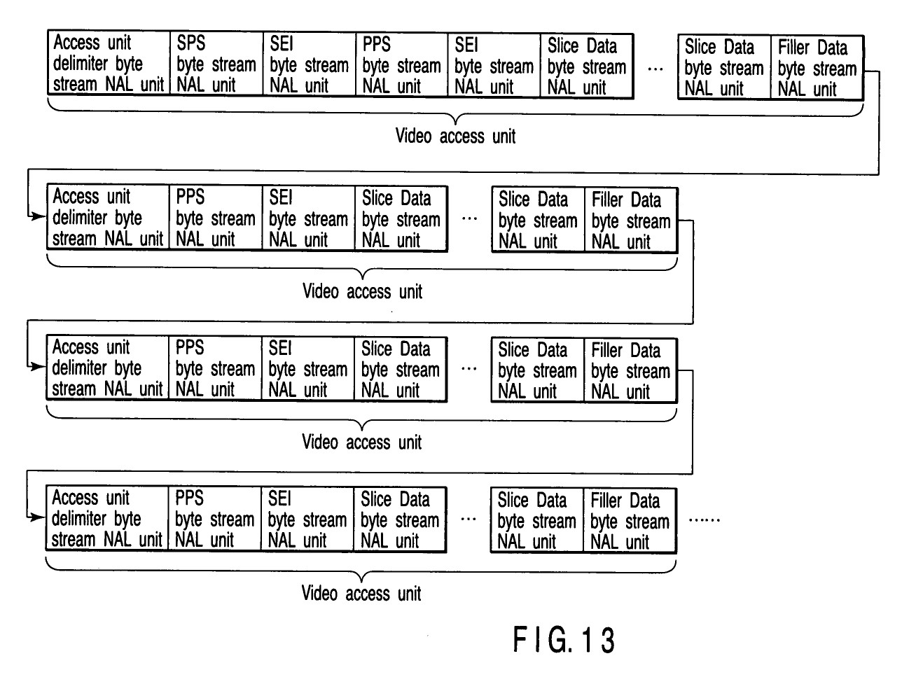

Next, the structures of a video data encoded by MPEG-2 and a video data encoded by MPEG-4 will be explained in reference to FIG. 12 and FIG. 13. A group of successive V-packs retrieved from the EVOBU illustrated in FIG. 12 (a) constitutes a video elementary stream (VIDEO PES: Video Packetized Elementary Stream) in the MPEG2 encoding. The video elementary stream (VIDEO PES: Video Packetized Elementary Stream) is a data sequence composed of a sequence header, I-picture, B-picture and P-picture. In addition, FIG. 12 (b) and (c) corresponds to the data structure shown in FIG. 11 (e), which indicates that the PES packet includes PES header and the video data (payload), and the video data (payload) within the PES packet belongs to the video elementary stream.

In comparison, in the encoding carried out by MPEG4, one encoded picture in the video elementary stream comprises one or a plurality of NAL units (Nal unit: Network Abstraction Layer) shown in FIG. 12 (d). Each NAL unit is unitized into a byte stream NAL unit by accompanying a start code prefix of a unique word and a stuffing having a given byte as illustrated in FIG. 12 (e). The byte stream NAL units constitutes the data series of a byte stream as illustrated in FIG. 12 (d), and is packetized as a payload data of the PES packet illustrated in FIG. 12 (c). The PES packet has the PES header and the PES packet data and the PES packet and the pack header are packed in a V-pack as illustrated in FIG. 12 (a) and (b). Further, the concept of an I-picture, P-picture and B-picture does not exist in MPEG4. By dividing one picture in slices, I-slice, P-slice, or B-slice is assigned per slice in MPEG4. Further, in contrast to MPEG2, an encoded sequence and display sequence have no concept of a picture type in MPEG4, therefore, encoding is done in unrestricted sequence under predetermined conditions of, for example, a reference frame memory size. In addition, a different type of payload (data, such as SPS, PPS and Slices) shall not be mixed and stored in a NAL unit. Further, these data correspond to NAL payload one-on-one, and the data, such as SPS, PPS and Slices, shall not be divided into a plurality of NAL.

Further, as illustrated in FIG. 13, a video access unit, i.e., a GOVU (Group of Video access Unit) is compose of a group of one or plurality of byte stream Nal units, and is accessed in units of access units. Here, a Coded-Frame is composed of one or two video access units, and if one frame is encoded, an access unit corresponds to one Coded-Frame, and if one field is encoded, a set of two access units corresponds to one Coded-Frame. As illustrated in FIG. 12 (f), a Nal unit comprises a Nal header and a payload (NAL payload) including an RBSP (Raw Byte Sequence Payload) data. Further, as illustrated in FIG. 12 (g), the Nal header comprises a fixed bit placed at its head followed by a Nal reference item (Nal reference index: nal ref_idc) as reference item information and a Nal unit type (nal_unit_type). These nal_ref_idc and nal_unit_type will be explained in detail later.

As shown in FIG. 13, RBSP data carried in the payload of NAL units begins with an access unit delimiter followed by a sequence parameter set (SPS) followed by supplemental enhancement information (SEI) followed by a picture parameter set (PPS) followed by SEI followed by a picture (Slice data), which contains only I-slice, followed by any subsequent combination of access unit delimiter, a PPS, an SEI and slices. At the end of the access unit, filler data and end of sequence (not shown) may exist. At the end of the GOVU, filler data exists and end of the sequence may exist.

In the DSI (Disk Search Information) data a3-44 shown in FIG. 11 (d), DSI general information (DSI_GI) is written. In the DSI general information (DSI_GI), an address of an end pack belonging to the EVOBU a2 is written as the EVOBU end address (EVOBU_EA), from which address (EVOBU_EA) of the next EVOBU can be searched. Further, in the DSI data a3-44, an end address of the first reference picture (EVOBU_{—}1STREF_EA) belonging to the aforementioned EVOBU a2, an end address of the second reference picture (EVOBU_{—}2NDREF_EA) belonging to the aforementioned EVOBU a2, and an end address of the third reference picture (EVOBU_{—}3RDREF_EA) belonging to the aforementioned EVOBU a2 are written.

In the field of the end address of this first reference picture (EVOBU_{—}1STREF_EA), an address of the video pack is described. In this video pack, the final data of a first search picture after the aforementioned DSI packet a3-4 is recorded with the number of relative logical blocks (RLBN) from the first logical block (LB) of the EVOBU a2 in which the aforementioned DSI packet a3-4 is recorded. If an I-picture does not exist (there is no video data) in the aforementioned EVOBU a2, (0000 0000h) is entered in the EVOBU_{—}1STREF_EA. Otherwise, a valid address is described in the field of the EVOBU_{—}1STREF_EA.

Here, the implication of the first search picture differs between (1) MPEG-2 and (2) MPEG-4 AVC. In other words, in case of (1) MPEG-2 or SMPTE, the first encoded reference picture (the first I-picture) in the aforementioned EVOBU a2 is relevant. Here, the first encoded reference picture (the first I-picture) comprises either, (i) I-frame picture, (ii) a complementary pair of two I-field pictures, or (iii) a complementary pair of two I-field pictures and a P-field picture. Further, a field picture in complementary pair means that it can compose a picture for one frame. Alternatively, in case of (2) MPEG-4 AVC, a first reference Coded-Frame, in other words the first I-Coded-Frame, where the Nal reference index (nal_ref_idc) is 3 (nal_ref_idc=3) in the Nal unit (nal_unit( )) of the slice data, associated sequence parameter set (SPS) and picture parameter set (PPS), is relevant.

Next, in the field of the end address of the second reference picture (EVOBU_{—}2NDREF_EA), an address of the video pack is described. In this video pack, final data of a second search picture after the aforementioned DSI packet a3-4 is recorded with the number of relative logical blocks (RLBN) from the head logical block (LB) of the EVOBU a2 in which the aforementioned DSI packet a3-4 is recorded. If there is no second search picture in the aforementioned EVOBU a2, (0000 0000h) is entered in the EVOBU_{—}2NDREF_EA.

Here, the implication of the second search picture equivalently differs between (1) MPEG-2 and (2) MPEG-4 AVC. In other words, in case of (1) MPEG-2 or SMPTE, the second encoded reference picture (I-picture or P-picture, normally the first P-picture) after the aforementioned EVOBU a2 is relevant. Here, the I-picture or P-picture relevant to the second encoded reference picture comprises either, (i) I- or P-frame picture, (ii) a complementary pair of two I- or P-field pictures, or (iii) a complementary pair of two I-field pictures and a P-field picture. Further, the complementary pair means that it can compose a picture for one frame. Alternatively, in case of (2) MPEG-4 AVC, the second search picture is relevant to the second search Coded-Frame, which refers only to the I-Coded-Frame relevant to the aforementioned EVOBU_{—}1STREF_EA. Here, the second search Coded-Frame corresponds to the second Coded-Frame where the Nal reference index (nal_ref_idc) is 3 (nal_ref_idc=3) in the Nal units (nal_unit( )) of a sequence parameter set (SPS), if there is a slice data, associated picture parameter set (PPS), and, if there is a sequence parameter set (SPS).

Furthermore, in the field of the end address of the third reference picture (EVOBU_{—}3RDREF_EA), the address of the video pack is described with the number of relative logical blocks (RLBN) from the first logical block (LB) of the EVOBU a2 in which the aforementioned DSI packet a3-4 is recorded. In this video pack, final data of a third search picture following the aforementioned DSI packet a3-4 is recorded. If there is no third search picture in the aforementioned EVOBU a2, (0000 0000h) is entered in the EVOBU_{—}2NDREF_EA.

Here, the implication of the third search picture equivalently differs between (1) MPEG-2 and (2) MPEG-4 AVC. In other words, in case of (1) MPEG-2, the third encoded reference picture (I-picture or P-picture, usually the second P-picture) in the aforementioned EVOBU a2 is relevant. Here, the I-picture or P-picture relevant to the third encoded reference picture comprises either, (i) I- or P-frame picture, (ii) a complementary pair of two I- or P-field pictures, or (iii) a complementary pair of two I-field pictures and a P-field picture. Further, the complementary pair means that it can compose a picture for one frame. Furthermore, in case of (2) MPEG-4 AVC, in reference to only the aforementioned EVOBU_{—}1STREF_EA and EVOBU_{—}2NDREF_EA, or the encoded frame corresponding to EVOBU_{—}1STREF_EA or EVOBU_{—}2NDREF_EA, the third Coded-Frame, i.e., the third search Coded-Frame, where the Nal reference index (nal_ref_idc) is 3 (nal_ref_idc=3) in the Nal units (nal_unit( )) of a sequence parameter set (SPS), if there is a slice data, associated picture parameter set (PPS), a sequence parameter set (SPS).

In MPEG-2, the EVOBU a2 is considered to contain a number of picture access units (PAUs). In some cases, the second coded reference picture and the third reference picture belong to a picture access unit (PAU) other than the first picture access unit (PAU). In such case, the EVOBU_{—}2NDREF_EA and EVOBU_{—}3RDREF_EA are calculated beyond the boarder of the picture access unit (PAU).

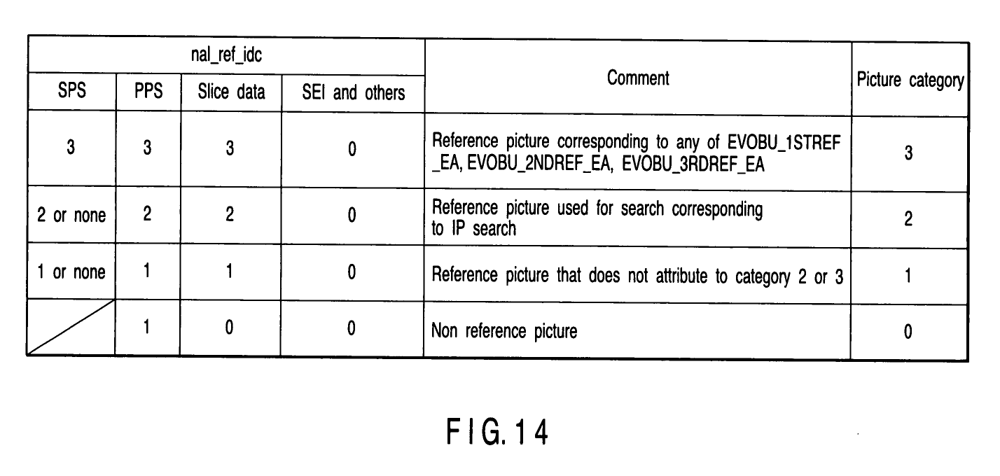

Further, regarding a Video Elementary Stream conforming to MPEG-4 AVC, a plurality of picture categories are fixed by assigning priority information (0, 1, 2, 3) to the Nal reference index (nal_ref_idc) for a certain picture. FIG. 14 illustrates the relation between the priority information (0, 1, 2, 3) assigned to the Nal reference index (nal_ref_idc) and the category.

A Nal unit (Nal unit: Network Abstraction Layer) is made up of a NAL header and a payload following the NAL header, the payload containing RBSP (Raw Byte Sequence Payload) data equivalent to a compressed data of motion-picture. The NAL header contains nal_ref_idc, in which a flag is specified for indicating whether it is a reference picture or not, and nal_unit_type, which is an identifier specifying the type of NAL unit. In MPEG-4 AVC, nal_ref_idc=0 is applied to a NAL unit for the slice data which does not contribute to produce the reference picture, and is also applied to a data NAL unit which is not necessarily used in the decoding process. A nonzero value (=1, 2, 3) is set in nal_ref_idc in a NAL unit for SPS, PPS or slice data used for production of a reference picture. Nal_ref_id is a positive value of 2 bits, which can take the value of 0 to 3 (4 values). In the MPEG-4 standard, the difference of nal_ref_id=1 to 3 is undefined.

One category among the four categories (category 0 to 3) is provided per group (Name shall be defined: hereinafter called “coded frame data” for now) of NAL units (slice data, PPS (if any), SPS (if any), SEI (if any), etc.) producing one Coded-Frame. In each category, the value of nal_ref_idc in a NAL unit, which contains coded frame data, is uniquely determined. FIG. 14 specifies its relation. In addition, in the MPEG-4 standard, SPS (if any) is allowed only for the first I-picture in the second or the third GOVU in an EVOBU.

In the Coded-Frame data of category 3, 3 is fixed for the nal_ref_idc of slice data NAL, SPS NAL (if any) and PPS NAL (if any), whereas 0 is fixed for the nal_ref_idc of SEI NAL (if any).

In the Coded-Frame data of category 2, 2 is fixed for the nal_ref_idc of slice data NAL, SPS NAL (if any) and PPS NAL (if any), whereas 0 is fixed for the nal_ref_idc of SEI NAL (if any).

In the Coded-Frame data of category 1, 1 is fixed for the nal_ref_idc of slice data NAL, SPS NAL (if any) and PPS NAL (if any), whereas 0 is fixed for the nal_ref_idc of SEI NAL (if any).

In the Coded-Frame data of category 0, 0 is fixed for nal_ref_idc of all NAL. The Coded-Frame data of category n (n=0˜3) is coded in order to enable decoding by referring only the Coded-Frame data greater or equal to category n.

In particular, the Coded-Frame of category 3 is coded by taking only the Coded-Frame of category 3 as a reference frame. The Coded-Frame of category 2 is coded by utilizing the Coded-Frames of category 2 and category 3 as reference frames. Further, the Coded-Frames of category 1 and category 0 can use the Coded-Frames of categories 1 to 3 as reference frames.

However, the Coded-Frame itself of category 0 shall not be used as a reference frame.

Here, category 0 is substantially equivalent to the B-picture in MPEG-2.

Upon coding, the Coded-Frame data of category 3 shall be coded in order to enable the Coded-Frame of category 3 to decode properly even when decoding is carried out after nullifying the Coded-Frame data of category 2 or under.

Further, the Coded-Frame data of category 3 and category 2 shall be coded in order to enable the Coded-Frame of categories 2 and 3 to decode properly even when decoding is carried out after nullifying the Coded-Frame data of category 1 or under.

Further, the Coded-Frame data of category 3, category 2 and category 1 shall be coded in order to enable the Coded-Frame of categories 3, 2 and 1 to decode properly even when decoding is carried out after nullifying the Coded-Frame data of category 0.

Further, the Coded-Frame data of category 2 and category 3 shall have the decoding sequence and display sequence consistent.

The Coded-Frames indicated by EVOBU_{—}1STREF_EA, EVOBU_{—}2NDREF_EA and EVOBU_{—}3RDREF_EA each belong to the aforementioned category 3.

By the above mentioned, a fast-forward playback in different reproduction speed is made possible in the 5 types of method mentioned below. Further, upon normal playback, Coded-Frame data of all categories are decoded.

(Fast-Forward 1)

Data up to EVOBU_{—}1STREF_EA is decoded per EVOBU and displayed. Subsequently, jumps to the head of the next VOBU to be reproduced.

(Fast-Forward 2)

Among data up to EVOBU_{—}2NDREF_EA, only the Coded-Frame data of category 3 selected by using nal_ref_idc and nal_unit_type is decoded per EVOBU. Subsequently, jumps to the head of the next VOBU to be reproduced.

(Fast-Forward 3)

Among data up to EVOBU_{—}3RDREF_EA, only the Coded-Frame data of category 3 selected by using nal_ref_idc and nal_unit_type is decoded per EVOBU. Subsequently, jumps to the head of the next VOBU to be reproduced.

(Fast-Forward 4)

Only the Coded-Frame data of category 3 is selected and decoded. While the moving pictures of fast-forward 3 and fast-forward 4 are the same, fast-forward 3 enables fast-forward playback efficiently without the occurrence of reading in unnecessary data as it jumps to the head of the next VOBU at the time of reading in the coded data up to the EVOBU_{—}3RDREF_EA.

(Fast-Forward 5)

Only the Coded-Frame data of category 2 and category 3 are selected and decoded.

(Fast-Forward 6)

Only the Coded-Frame data of categories 1, 2 and 3 are selected and decoded. They are displayed after permuting the decode sequence of the decoded frames to a display sequence of the decoded frames.

Further, in the fast-forward 1 to 5, owing to the consistency of the decoding sequence and the display sequence, decoding and display are done sequentially in frame units regardless of permutation.

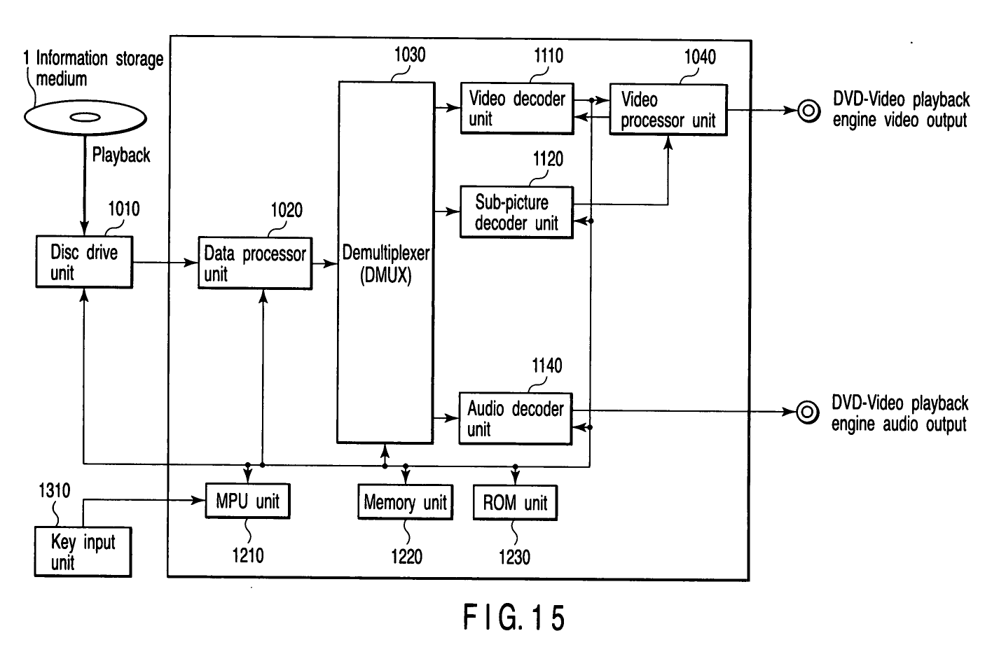

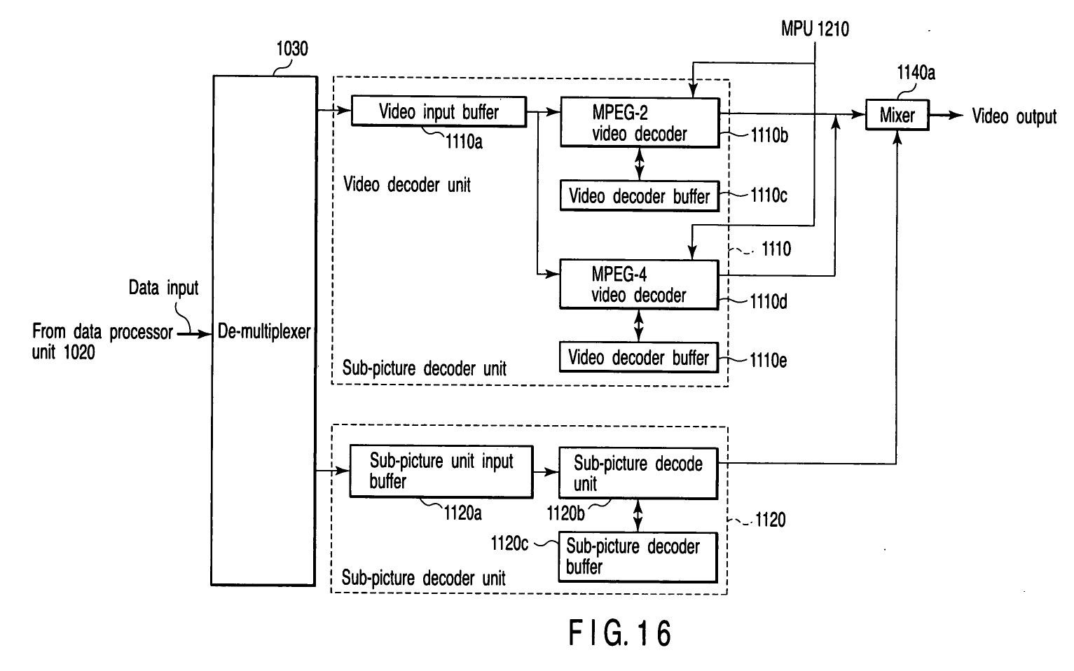

FIG. 15 and FIG. 16 show a reproducing apparatus for reproducing video from an optical disk, which is provided with the structure illustrated in FIG. 1 to FIG. 11. In reference to FIG. 15 and FIG. 16, a playback operation of a video from an optical disk will be explained.

When a reproduction apparatus is in operation, an HD_DVD video disk is retrieved from a lead-in area of an optical disk 1 by an optical pickup (not shown) of disk drive section 1010 and retrieved data is transferred to the data processor section 1020. First, HDVMG 30 is retrieved. In the case where a title is determined, an HDVTS attribute information table (HDVTS_ATRT) 314 corresponding to its title set is searched. Attribute information corresponding to the title set is retrieved, and each decoder 1110, 1120 and 1140 is set according to its attribute. Further, an HD video title set (HDVTS) 40 for a video title is selected by using the title search pointer table (TT_SPRT) 311 of the HDVMG 30 and the selected HD video title set (HDVTS) 40 is searched. If needed, attribute information is read out from the HD video title set information (HDVTSI) anew, and each decoder 1110, 1120 and 1140 is set anew according to its attribute. Regarding title reproduction, the HDVTS program chain information table (HDVTS_PGCIT) 412 is searched, and EVOB a2 shown in FIG. 11 is read out one after the other from the video object for title (HDVTSTT_VOBS) 43.

In the case where the advanced HD video title set (AHDVTS) 50 is assigned, the advanced HD video title set information (AHDVTSI) is searched without referring to the HDVMG 30. Attribute information (ATR1) of the enhanced video object for advanced title (AHDVTSTT_VOBS) 53 is retrieved, and each decoder 1110, 1120 and 1140 is set, correspondingly, according to its attribute. Subsequently, the enhanced video object for advanced title (AHDVTSTT_VOBS) 53 is searched, and the EVOB a2 shown in FIG. 11 is read out one after the other.

The read out EVOB a2 is supplied to a Demultiplexer 1030 shown in FIG. 15 via the data processor section 1020. In the Demultiplexer 1030, packet a3, a4, a6 and a7 are demultiplexed from VOBU. The video data recorded in the packet data within the video pack a4 is supplied to the video decoder unit 1110, the sub-picture data recoded in the packet data within the sub-picture pack a7 is transferred to the sub-picture decoder unit 1120, and the audio data recorded in the packet within the audio pack a6 is transferred to the audio decoder unit 1140. The supplied data is decoded at each decoder units 1110 to 1140, arbitrarily combined in the video processor unit 1040, and is converted into analog signals at the D/A converters 1320 and 1330 and output thereafter. The series of process is managed by the MPU unit 1210 in integrative manner, whereby data in need of temporary storage during processing is stored temporary at the memory section 1220. Further, process programs to be processed at the MPU unit 1210 and preset fixed information are recorded in the ROM unit 1230. Although FIG. 15 illustrates that an information input from a user to the information reproduction apparatus is done by key input at the Key input unit 1310, the key input unit 1310 could also be a commonly used remote controller.

As illustrated in FIG. 15, the video decoder unit 1110 and the sub-picture decoder unit 1120 are organized as shown in FIG. 15. In reference to this FIG. 15, the video decoder unit 1110 and sub-picture unit 1120 will be explained further in detail.

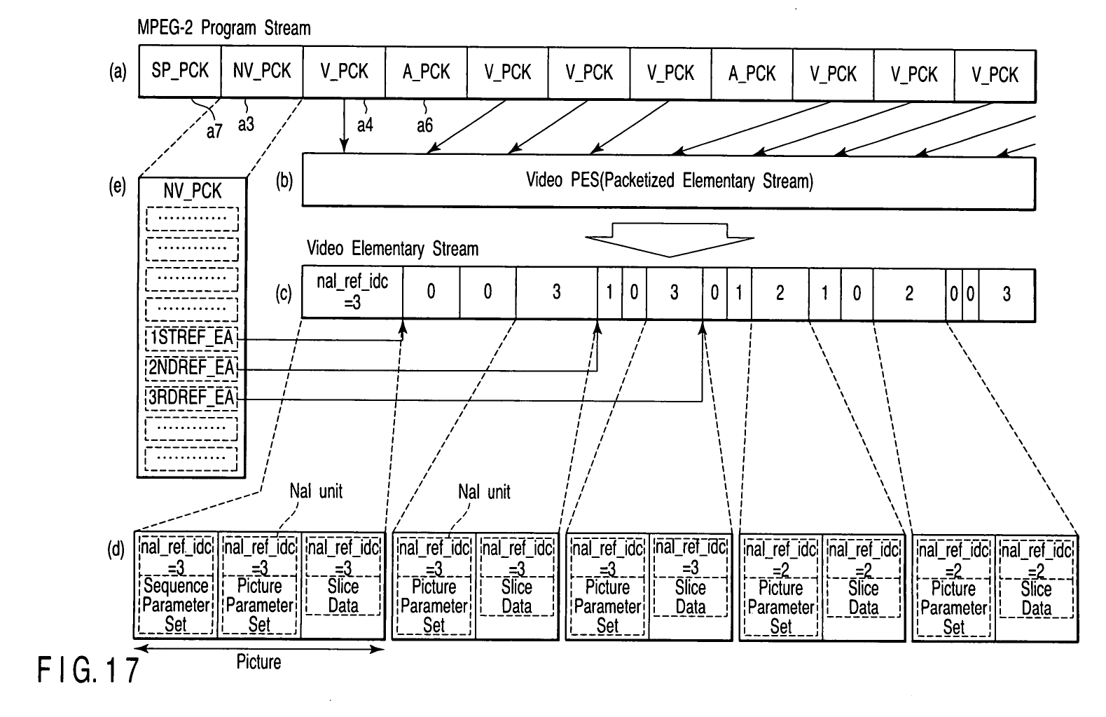

In the Demultiplexer 1030, the EVOBU a2 shown in FIG. 11 is input one after the other. More specifically, as illustrated in FIG. 17 (a), a navigation pack (NV_PCK) a3 followed by a video pack (V_PCK) a4, audio pack (A_PCK) a6 and a sub-picture pack (SP_ACK) a7 are supplied to the Demultiplexer 1030 as an MPEG-2 program stream. The navigation pack (NV_PCK) a3 is stored in the memory unit 1220 as a control information, and the video pack (V_PCK) a4, audio pack (A_PCK) a6 and sub-picture pack (SP_ACK) a7 are input respectively into the video decoder unit 1110, the audio decoder 1140 and the sub-picture decoder unit 1120. The video decoder unit 11 comprises a video input buffer 1110a, an MPEG-2 video decoder 1111b and video decoder buffer 1110c along with an MPEG-4 video decoder 1111b and video decoder buffer 1110e, and is operated by selecting either one of the MPEG-2 video decoder 1111b or the MPEG-4 video decoder 1111b with the control signal from the MPU unit 1210 in accordance with the video attribute (HDVTS_V_ATR, ATR1_V_ATR).

The video pack (V_PCK) a4, which is de-multiplexed at the Demultiplexer 1030, is stored temporary in the video input buffer 1110a as a packetized video elementary stream (VIDEO PES: Video Packetized Elementary Stream) shown in FIG. 17 (b), and is input to the selected MPEG-2 video decoder 1111b and MPEG-4 video decoder 1111b. If the elementary stream (VIDEO PES) is a sequence video data compressed in accordance with MPEG2, it will be decoded at MPEG-2 video decoder 1111b and stored temporary in the video decoder buffer 1110c. It will then be output to the mixer 1140a and is mixed with the sub-picture signal in the mixer 1140a, and output as a video signal. Further, if the elementary stream (VIDEO PES) is an alignment of NAL units compressed in accordance with MPEG 4 as shown in FIG. 12 (d), it will be decoded at MEG-4 video decoder 1111d, stored temporary in the video decoder buffer 1110e, output to the mixer 1140a and mixed with the sub-picture signal in the mixer 1140a and output as a video signal.

As explained earlier, in the MPEG-2 video decoder 1111b, for normal playback, video is output after the I, P, and B pictures are decoded in turn. A NAL unit conforming to the MPEG 4 shown in FIG. 12 as well as in FIG. 17 (c) and (d) is decoded at MPEG-4 video decoder 1111d in turn, generates playback picture frames and is output as a video signal.

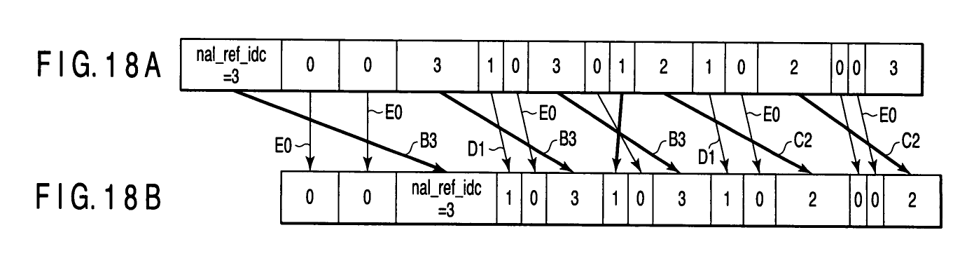

FIG. 17 (c) shows an example of an alignment of the Nal unit arranged in the order to be decoded. At the head is arranged three Nal units possessing nal_ref_idc=3 (a Nal unit containing SPS, PPS and slice data bearing the priority of nal_ref_idc=3 shown in FIG. 17 (d), which is followed by the arrangement of other Nal units (nal_ref_idc=0). In the video elementary stream, the three Nal units bearing nal_ref_idc=3 for decode is arranged in order to make an appearance one after the other. As an example, upon normal playback, a Nal unit (nal_ref_idc=0) arranged in the decode sequence (the same sequence as FIG. 17 (c) as shown in FIG. 18A will be displayed in the sequence shown in FIG. 18B after decoding. In FIGS. 18A and 18B, arrows B3 and C2 shown in thick solid lines show that the plurality of Nal units possessing nal_ref_idc=3 or nal_ref_idc=2 are shifted in the sequence to be decoded and in the sequence to be displayed. Arrows D1 and E0 illustrated in thin solid lines show that the plurality of Nal units possessing nal_ref_idc=1 or nal_ref_idc=0 are shifted in the sequence to be decoded and in the sequence to be displayed, intersect with arrows B3 and B2 illustrated in thick solid lines and are permuted. Although the Nal unit possessing nal_ref_idc=1 is a reference picture, in the normal playback mode, it has no problem permuting the display sequence as it intersects with arrows B3 and B2 as illustrated by arrow D1. However, when referred to upon high speed playback (special playback mode), as it is necessary to carry out permutation of display sequence, it is considered to be unsuitable for high-speed playback (special playback mode). Since all Nal units possessing nal_ref_idc=0 are not reference pictures, they are naturally considered unsuitable for high-speed playback. The address up to the Nal unit possessing this nal_ref_idc=3 is written in the NV pack (NV_PCK) from the head of the VOBU as a relative number of logical blocks, which has been explained earlier as EVOBU_{—}1STREF_EA, EVOBU_{—}2NDREF_EA and EVOBU_{—}3RDREF_EA shown in FIG. 17 (e).

As to the special playback mode including the FF playback and FR playback, pictures are displayed in turn with reference to EVOBU_{—}1STREF_EA, EVOBU_{—}2NDREF_EA and EVOBU_{—}3RDREF_EA written in the DSI.

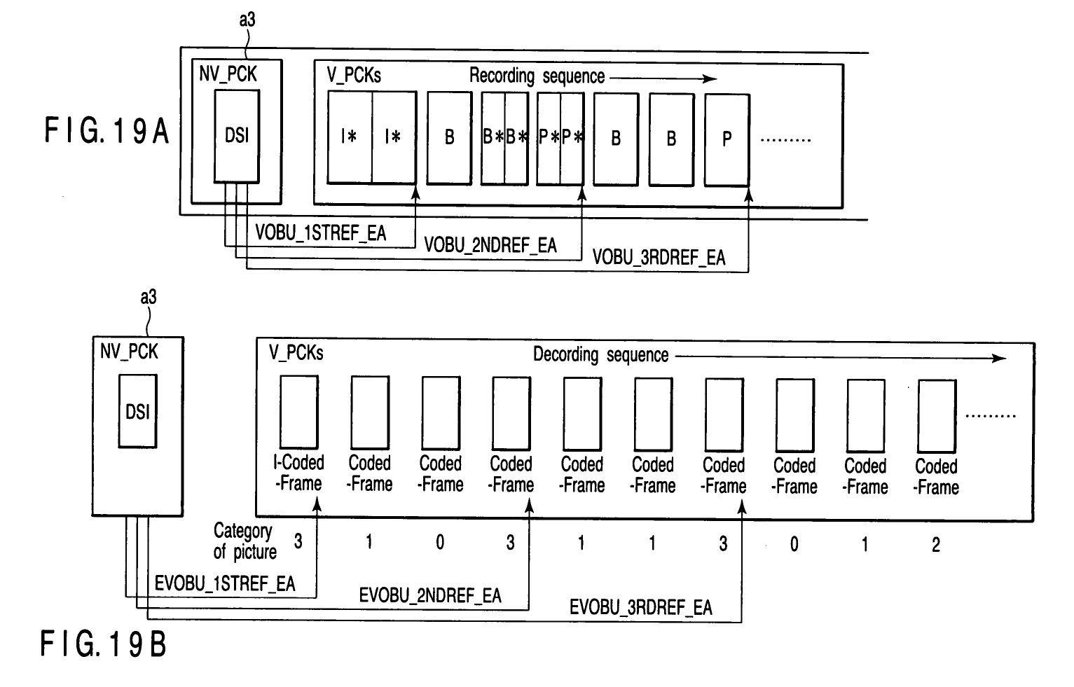

With regard to the special playback mode in the sequence of MPEG2 encoded by MPEG-2, high-speed playback is performed by taking out the pictures assigned by EVOBU_{—}1STREF_EA, EVOBU_{—}2NDREF_EA and EVOBU_{—}3RDREF_EA, from the EVOBU, in compliance with the reproduction speed as illustrated in FIG. 19A. A so-called only I picture playback, which assigns only the EVOBU_{—}1STREF_EA, enables the fastest high-speed playback. For example, only the reproduction of I pictures is achieved by taking out the two I picture fields I* and I* from the EVOBU by the EVOBU_{—}1STREF_EA as illustrated in FIG. 19A. If the high-speed playback speed is slow, the P picture filed P* and P* assigned by EVOBU_{—}2NDREF_EA or EVOBU_{—}3RDREF_EA1, or even the P picture frame P assigned by EVOBU_{—}3RDREF_EA1 are taken out, whereby a high-speed playback having a relatively slow reproduction speed is achieved.

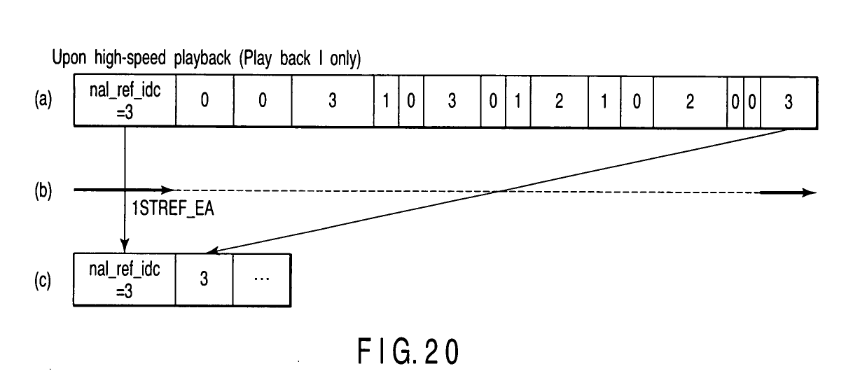

As to the MPEG4 bit stream encoded by MPEG-4, the group of Nal units belonging to category 3, as explained with reference to FIG. 14, and assigned by EVOBU_{—}1STREF_EA are taken out and decoded, whereby an I-Coded Frame as illustrated in FIG. 19B is taken out from the EVOBU. A high-speed playback is achieved by reproducing this I Coded Frame in sequence. More specifically, in the so-called only I picture reproduction, the Nal unit belonging to category 3 and possessing nal_ref_idc=3 which is first emerged in the sequence is picked up from the Nal units arranged in the decoding sequence in the one of EVOBUs shown in FIG. 20 (a) with reference to EVOBU_{—}1STREF_EA as shown in FIG. 20 (b). It is then determined as the first Nal unit to be decoded and to compose a picture for reproduction as shown in FIG. 20 (c). The next EVOB is searched by pickup, whereby a Nal unit equivalently belonging to category 3 and is the first to emerge possessing nal_ref_idc=3 is readout from this EVOB with reference to EVOBU_{—}1STREF_EA as illustrated in FIG. 20 (b). It is then determined as the next Nal unit to be decoded and to compose a picture for reproduction as illustrated in FIG. 20 (c). In this manner, a Nal unit belonging to category 3 and is the first emerging Nal unit possessing nal_ref_idc=3 is retrieved from an EVOB in sequence, whereby a picture is reproduced in the reproduction sequence shown in FIG. 20 (c), which achieves the only I picture reproduction.

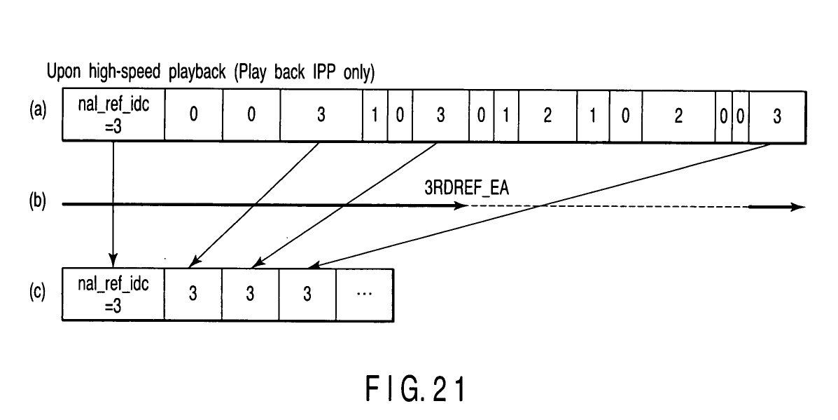

In the bit stream of MPEG 4, as for the high-speed playback slower than the so-called only I picture reproduction (a so-called IP reproduction or the IPP reproduction), a group of Nal units assigned by EVOBU_{—}2NDREF_EA or EVOBU_{—}3RDREF_EA1 and belonging to category 3 is retrieved and decoded, whereby a Coded Frame is retrieved in order to achieve the so-called IP reproduction or IPP reproduction in relatively slow reproduction speed. More specifically, up to a Nal unit possessing nal_ref_idc=3 assigned by EVOBU_{—}2NDREF_EA or EVOBU_{—}3RDREF_EA1 and belonging to category 3 with respect to one EVOB is read out from a Nal units aligned in the decoding sequence shown in FIG. 21 (a) as shown in FIG. 21 (b). It is then decoded and determined as a Nal unit composing a picture for reproduction as shown in FIG. 21 (c). The next EVOB is searched by pickup, whereby a Nal unit equivalently belonging to category 3 and possessing nal_ref_idc=3 assigned by EVOBU_{—}2NDREF_EA or EVOBU_{—}3RDREF_EA1 is readout from this EVOB as illustrated in FIG. 21 (b). It is then determined as the next Nal unit to be decoded and to compose a picture for reproduction as shown in FIG. 21 (c). In this manner, a Nal unit belonging to category 3 and possessing nal_ref_idc=3 assigned by EVOBU_{—}2NDREF_EA or EVOBU_{—}3RDREF_EA1 is retrieved from one EVOB in sequence, whereby a picture is reproduced in the reproduction sequence shown in FIG. 21 (c), which achieves the so-called IP reproduction and IPP reproduction.

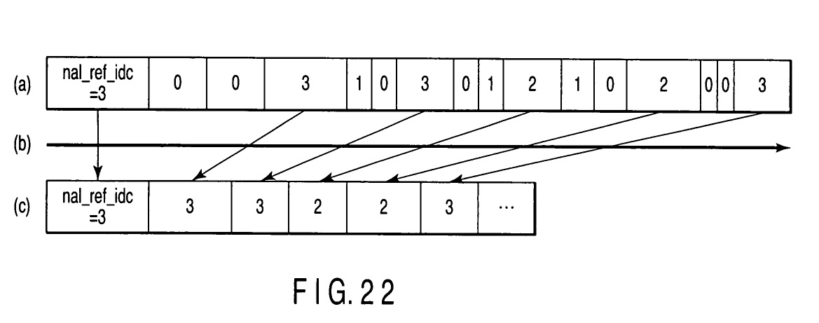

The bit stream of MPEG 4 achieves yet a slower high-speed playback (a so-called IPPP reproduction) than the so-called IP reproduction or the IPP reproduction. In the so-called IPPP reproduction, in addition to the group of Nal units belonging to category 3 and assigned by EVOBU_{—}3RDREF_EA3, a group of Nal units belonging to category 2 is retrieved and decoded, whereby a Coded-Frame is retrieved, and the so-called IPPP reproduction is achieved. More specifically, all Nal units possessing nal_ref_idc=3 and nal_ref_idc=2, which belong to category 2 with respect to one EVOB, are retrieved as illustrated in FIG. 22 (b) from the Nal unit aligned in the decoding sequence shown in FIG. 22 (a), decoded as illustrated in FIG. 22 (c), and determined as a Nal unit composing a picture to be reproduced. The next EVOB is searched by pickup, whereby all Nal units possessing nal_ref_idc=3 and nal_ref_idc=2, which equivalently belong to category 2, are readout from this EVOB as illustrated in FIG. 22 (b). They are then determined as the next Nal unit to be decoded and to compose a picture for reproduction as shown in FIG. 22 (c). In this manner, all Nal units possessing nal_ref_idc=3 and nal_ref_idc=2, which belong to category 2, are retrieved from an EVOB in sequence, whereby a picture is reproduced in the reproduction sequence shown in FIG. 22 (c), and the so-called IP reproduction or IPP reproduction is achieved.

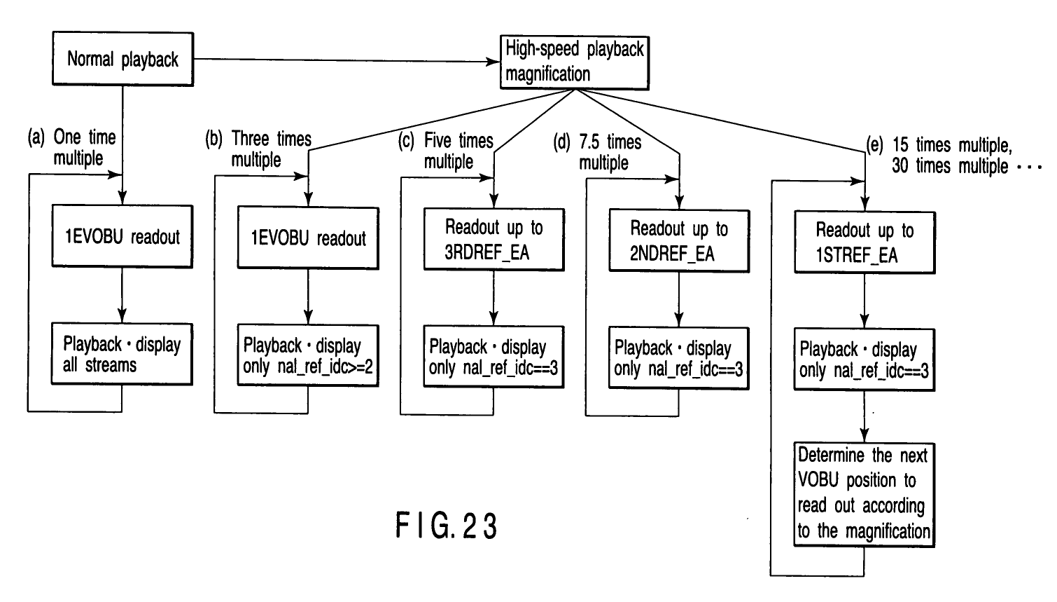

When explaining the high-speed playback magnification by taking the high-speed playback of the aforementioned MPEG4 bit stream as an example, the relations are illustrated as in FIG. 23. In the normal playback mode, one EVOBU is read out as illustrated in FIG. 23 (a), whereby a stream of MPEG4 belonging to one EVOBU is decoded and displayed. The next EVOBU is read out, and the stream of MPEG4 belonging to the EVOBU is decoded and displayed. Normal playback is performed by the repetition of this process. In a low multiple playback mode, such as a high-speed playback in three times multiple, similarly, as illustrated in FIG. 23 (b), one EVOBU is read out and a Nal unit corresponding to nal_ref_idc>2 and nal_ref_idc=2 belonging to one EVOBU is decoded, whereby a picture is displayed. The high-speed playback in the three times magnification is performed by the repetition of decoding the Nal unit and displaying the picture involved in this decoding. In a relatively low multiple playback mode, such as a high-speed playback in five times multiple, similarly, up to a Nal unit assigned by EVOBU_{—}3RDREF_EA1 belonging to one EVOBU is read out as illustrated in FIG. 23(c), and a Nal unit corresponding to nal_ref idc=3 is decoded, whereby a picture is displayed. The high-speed playback in the five times magnification is performed by the repetition of decoding the Nal unit and displaying the picture involved in this decoding. In a relatively high multiple playback mode, such as a high-speed playback in 7.5 times multiple, similarly, up to a Nal unit assigned by EVOBU_{—}2NDREF_EA1 belonging to one EVOBU is read out as illustrated in FIG. 23 (d), and a Nal unit corresponding to nal_ref_idc=3 is decoded, whereby a picture is displayed. The high-speed playback in the 7.5 times magnification is performed by the repetition of decoding the Nal unit and displaying the picture involved in this decoding. In a sufficiently high multiple playback mode, such as a high-speed playback in 15 times multiple or 30 times multiple, similarly, a Nal unit assigned by EVOBU_{—}1STREF_EA1 belonging to one EVOBU is read out as illustrated in FIG. 23 (e), and only a Nal unit corresponding to nal_ref_idc=3 is decoded, whereby a picture is displayed. Subsequently, in accordance with the magnification, the EVOBU of the next target is determined, and the high-speed playback in the 15 times magnification or 30 times magnification is performed by the repetition of decoding the Nal unit and displaying the picture involved in this decoding.

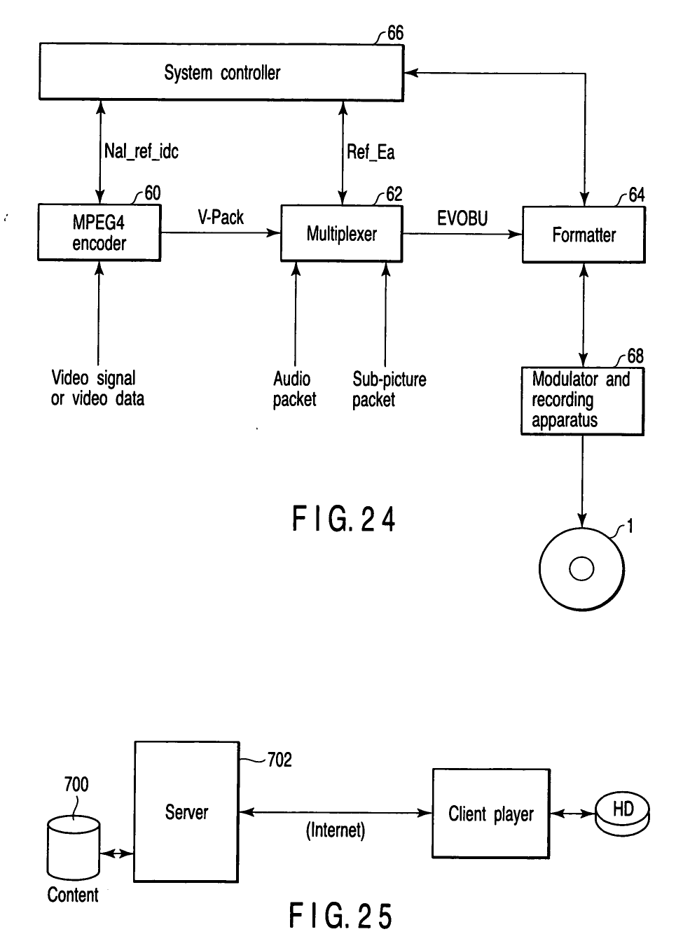

Next, the manufacturing apparatus and manufacturing method of an optical disk possessing data structures shown in FIGS. 1 to 11 are explained with reference to FIG. 24.

Regarding the apparatus shown in FIG. 24, an analogue video signal or a digital video data (in the present specification, both will be referred to as video signal) is input into the MPEG4 encoder 60. In the MPEG4 encoder 60, a frame or field of a video signal or a video data input under the control of the system controller 66, is analyzed in slice units, whereby a payload and Nal header are made to produce a Nal unit in sequence. When producing a Nal header, a flag shall be placed in accordance with the importance of the picture generated in the Nal unit explained with reference to FIG. 14, while providing the priority (3, 2, 1) to the value of the flag. The Nal unit aligned as a bit stream is separated into certain lengths as a packet data, is placed with a packet header, and further is placed with a pack header in order to produce a packet. As to the Nal unit aligned as a bit stream, an access unit is determined as a unit of access. However, this access unit is determined as the unit of the video packet aligned in the EVOBU. The produced pack is supplied to the Multiplexer 62 and is multiplexed with an audio packet and sub-picture packet produced by other encoders, whereby an EVOBU is produced. On producing the EVOBU, a DSI data and PCI data of the navigation pack (NV_PAK) is produced under the control of the system controller. On producing the DSI data, an EVOBU_{—}1STREF_EA, EVOBU_{—}2NDREF_EA and EVOBU_EVOBU_{—}3RDREF_EA1 are written in accordance with the Nal unit category and the alignment sequence of the Nal unit. An EVOBU starting from a navigation pack (NV_PAK) is supplied to a DVD formatter 64, where the EVOBU is gathered as a video object for title (HDVTSTT_VOBS) and produces one or a plurality of files, whereby a structure of a title set shown in FIG. 5 or FIG. 8 is produced. On producing this title set, the attribute information of the video (VTS_V_ATR, ATR1_V_ATR) will be written as a video stream of MPEG 4. In addition to the title set structure, a VMG etc. is added as a management information, and from the DVD formatter 64 a plurality of files bearing the HD DVD structure as shown in FIG. 1 are supplied to a modulator and recording apparatus 68. At the modulator and recording apparatus 68, the file data is modulated into a recording format by ECC processing, and a file in the structure shown in FIG. 1 is written in the primitive plate of the optical disk. With this writing process, the production of HD DVD optical disk is completed.

In the aforementioned explanation, an example of encoding in accordance with MPEG 4 is explained. However, by setting up an MPEG2 encoder as an alternative to, or, in addition to the MPEG4 encoder 60, an object encoded in accordance with MPEG2 can be produced. The explanation of the production of an optical disk from the object of this MPEG 2 pursuant to the HD DVD standard will be omitted as being equivalent to the aforementioned explanation.

The aforementioned embodiments explain an example of a video title recorded on an optical disk as an information storage medium. However, the information storage medium is not restricted to an optical disk, therefore, as long as the recording is done in an equivalent file structure, a hard disk or a high-capacity memory etc. is also considered applicable in the present invention. Further, obviously, the present invention is also applicable to a system, where a content of a video title is stored in the recording apparatus 700 on the server side, transferred to the client side from the server 702 via the internet or network, stored in a temporary recording apparatus 706, such as an HDD or a rewritable type optical disk apparatus, via a player 704 on the client side, and is reproduced by the player 704 as illustrated in FIG. 25. In this type of system, a data transferred via the internet or network is equivalent to the data transferred to the data processor unit 1020 via the optical disk to the disk drive 1010 as shown in FIG. 15.

The present invention concerning an optical disk, a method for reproducing this optical disk, a reproduction apparatus for reproducing this optical disk and a recording method as well as a recording apparatus to record data on the optical disk, enables special reproduction in all picture compression mode pursuant to the MPEG standard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information storage medium provided with a data recording area, comprising:
a video object to be reproduced, which is recorded in the data recording area, the video object comprising a number of video object units, which are arranged consecutively,
each of the video object units comprising a pack sequence including a navigation pack and video packs following the navigation pack,
the navigation pack having a picture information including address information and a picture category relating to a reference picture, the picture category being determined in compliance with the importance level in respect to the reference picture,
each of the video packs including a packet including a video data constituting a part of a stream of nal units which include a first group of the nal units contributing to produce the reference picture and a second group of the nal unit not contributing to produce the reference picture,
each of the nal units including a nal header and data payload, the nal header including reference item information which describes that the nal unit belongs to the first group and contributes to produce the reference picture, and a type of data of the payload, and
the reference item information further indicating the priority of the nal unit, which is determined in accordance with the category of the reference picture.

2. An information storage medium according to claim 1, wherein the address of the picture information corresponds to an end address of the video pack within the video object unit which contributes to produce the reference picture.

3. An information storage medium according to claim 1, wherein the data recording area contains a management area to manage the object, an encoded mode of a video data within the video pack is described in the management area, and the encoded mode is MPEG4 AVC.

4. An information storage medium according to claim 1, wherein the priority of the nal unit contains one of no priority, and first, second and third priorities, and a reference picture produced by the combination of the first group of the nal units including a nal unit with the third priority described in the reference item information belongs to a picture category in the importance level.

5. An information storage medium according to claim 4, wherein the first group of the nal units includes first, second and third nal units, the first nal units have a nal unit header in which a data type is described as a sequence parameter set and a payload of the sequence parameter set, a second nal unit has a nal unit header in which a data type is described as a picture parameter set and a payload of the picture parameter set, a third nal unit has a nal unit header in which a data type is described as a slice data and a payload of the slice data, the third priority is described in the nal unit headers of the first, second and third nal units, the reference picture produced by the combination of the first, second and third nal units belongs to the picture category in the importance level, and the picture information includes an end address of the video pack within the video object unit which contributes to produce the reference picture belonging to a picture category in the importance level and the first to appear within the video object unit.

6. An information storage medium according to claim 5, wherein the picture information includes an end address of the video pack within the video object unit which contributes to produce the reference picture belonging to a picture category in the importance level and appears secondly within the video object unit.

7. An information storage medium according to claim 5, wherein the picture information includes an end address of the video pack within the video object unit which contributes to the production of a reference picture belonging to a picture category in the importance level and appears thirdly within the video object unit.

8. An information storage medium according to claim 4, wherein a reference picture produced by the combination of the first, second, and third nal units of the second priority belongs to a category in the second importance level.

9. A reproduction apparatus for reproducing a video signal from an information storage medium provided with a data recording area which includes;
a video object to be produced, which is recorded in the data recording area, the video object comprising a number of video object units, which are arranged consecutively,
each of the video object units comprising a pack sequence containing a navigation pack and video packs following the navigation pack,
the navigation pack having a picture information including address information and a picture category relating to a reference picture, the picture category being determined in compliance with the importance level in respect to the reference picture,
the video pack including a packet, a sequence of the packets constituting a stream of nal units which include a first group of the nal units contributing to produce the reference picture and a second group of the nal unit not contributing to produce the reference picture,
each of the nal units including a nal header and data payload, the nal header including reference item information which describes that the nal unit belongs to the first group and contributes to produce the reference picture, and a type of data of the payload, and
the reference item information indicating the priority of the nal unit, which is determined in accordance with the category of the reference picture;
said apparatus comprising:
a search unit configured to search for the video object unit in the recording area and to read out the pack sequence in reference to the picture information;
a de-multiplexer configured to demultiplex the video pack from the read out video object unit;
a decoder configured to pick up the nal units from the demultiplexed video packs and decode a combination of the nal units contributing to the production of a reference picture belonging to the category of a high importance level to a reference picture in reference to the priority of the nal unit, and
an output unit to output the video signal of the reference picture.

10. A reproduction apparatus according to claim 9, wherein the address of the picture information corresponds to an end address of the video pack within the video object unit which contributes to produce the reference picture, and the search unit reads out the pack sequence in reference to the end address.

11. A reproduction apparatus according to claim 10, wherein the data recording area contains a management area to manage the object, an encoded mode of a video data within the video pack is described in the management area, and the encoded mode is MPEG4 AVC, and
the search unit reads out the video pack in reference to the encoded mode.

12. A reproduction apparatus according to claim 9, wherein the priority of the nal unit contains one of no priority, and first, second and third priorities, and a reference picture produced by the combination of the first group of the nal units including a nal unit with the third priority described in the reference item information belongs to a picture category in the importance level, and
the decoder unit decodes the combination of the nal units containing a nal unit which has the third priority written in the reference item information.

13. A reproduction apparatus according to claim 12, wherein the first group of the nal units includes first, second and third nal units, the first nal units have a nal unit header in which a data type is described as a sequence parameter set and a payload of the sequence parameter set, a second nal unit has a nal unit header in which a data type is described as a picture parameter set and a payload of the picture parameter set, a third nal unit has a nal unit header in which a data type is described as a slice data and a payload of the slice data, the third priority is described in the nal unit headers of the first, second and third nal units, the reference picture produced by the combination of the first, second and third nal units belongs to the picture category in the importance level, and the picture information includes an end address of the video pack within the video object unit which contributes to produce the reference picture belonging to a picture category in the importance level and the first to appear within the video object unit, and
the decoder unit decodes the combination of the nal units with reference to the first end address.

14. A reproduction apparatus according to claim 13, wherein the picture information includes an end address of the video pack within the video object unit which contributes to produce the reference picture belonging to a picture category in the importance level and appears secondly within the video object unit, and
the decoder unit decodes the combination of the nal units with reference to the first and second end addresses.

15. A reproduction apparatus according to claim 14, wherein the picture information includes an end address of the video pack within the video object unit which contributes to the production of a reference picture belonging to a picture category in the importance level and appears thirdly within the video object unit, and
the decoder unit decodes the combination of the nal units with reference to the first, second and third end addresses.

16. A reproduction apparatus according to claim 12, wherein a reference picture produced by the combination of the first, second, and third nal units of the second priority belongs to a category in the second importance level, and
the decoder unit decodes the combination of the nal units belonging to a category in the second importance level.

17. A method of reproducing a video signal from the information storage medium which includes;
a video object to be produced, which is recorded in the data recording area, the video object comprising a number of video object units, which are arranged consecutively,
each of the video object units comprising a pack sequence containing a navigation pack and video packs following the navigation pack,
the navigation pack having a picture information including address information and a picture category relating to a reference picture, the picture category being determined in compliance with the importance level in respect to the reference picture,
the video pack including a packet, a sequence of the packets constituting a stream of nal units which include a first group of the nal units contributing to produce the reference picture and a second group of the nal unit not contributing to produce the reference picture,
each of the nal units including a nal header and data payload, the nal header including reference item information which describes that the nal unit belongs to the first group and contributes to produce the reference picture, and a type of data of the payload, and
the reference item information indicating the priority of the nal unit, which is determined in accordance with the category of the reference picture,
said method comprising:
searching for the video object unit in the recording area and to read out the pack sequence in reference to the picture information;
demultiplex the video pack from the read out video object unit;
picking up the nal units from the demultiplexed video packs and decode a combination of the nal units contributing to the production of a reference picture belonging to the category of a high importance level to a reference picture in reference to the priority of the nal unit, and
outputting the video signal of the reference picture.

18. A reproduction method according to claim 17, wherein the address of the picture information corresponds to an end address of the video pack within the video object unit which contributes to produce the reference picture, and
the searching for the video object includes reading out the pack sequence in reference to the end address.

19. A reproduction method according to claim 18, wherein the data recording area contains a management area to manage the object, an encoded mode of a video data within the video pack is described in the management area, and the encoded mode is MPEG4 AVC, and
the searching for the video object includes reading out the video pack in reference to the encoded mode.

20. A reproduction method according to claim 17, wherein the priority of the nal unit contains one of no priority, and first, second and third priorities, and a reference picture produced by the combination of the first group of the nal units including a nal unit with the third priority described in the reference item information belongs to a picture category in the importance level, and
the picking up the nal units includes decoding the combination of the nal units containing a nal unit which has the third priority written in the reference item information.

21. A reproduction method according to claim 20, wherein the first group of the nal units includes first, second and third nal units, the first nal units have a nal unit header in which a data type is described as a sequence parameter set and a payload of the sequence parameter set, a second nal unit has a nal unit header in which a data type is described as a picture parameter set and a payload of the picture parameter set, a third nal unit has a nal unit header in which a data type is described as a slice data and a payload of the slice data, the third priority is described in the nal unit headers of the first, second and third nal units, the reference picture produced by the combination of the first, second and third nal units belongs to the picture category in the importance level, and the picture information includes an end address of the video pack within the video object unit which contributes to produce the reference picture belonging to a picture category in the importance level and the first to appear within the video object unit, and the picking up the nal units includes decoding the combination of the nal units with reference to the first end address.

22. A reproduction method according to claim 21, wherein the picture information includes an end address of the video pack within the video object unit which contributes to the produce the reference picture belonging to a picture category in the importance level and appears secondly within the video object unit, and
the picking up the nal units includes the combination of the nal units with reference to the first and second end addresses.

23. A reproduction method according to claim 22, wherein the picture information includes an end address of the video pack within the video object unit which contributes to the production of a reference picture belonging to a picture category in the importance level and appears thirdly within the video object unit, and
the picking up the nal units includes decoding the combination of the nal units with reference to the first, second and third end addresses.

24. A reproduction method according to claim 20, wherein a reference picture produced by the combination of the first, second, and third nal units of the second priority belongs to a category in the second importance level, and
the picking up the nal units includes decoding the combination of the nal units belonging to a category in the second importance level.

25. A recording apparatus for recording a video object in a recording area of the information storage medium, comprising:
an encode unit configured to encode an input video signal to a stream of nal units each including a nal header and a data payload, allocate the nal units in packets to produce a video elementary stream of packets and allocate the packets in packs, respectively, to produce a MPEG video stream, the nal units being classified into a first group of the nal units contributing to produce a reference picture and a second group of the nal units not contributing to produce the reference picture, the nal unit header including reference item information which describes that the nal unit belongs to the first group and contributes to produce the reference picture, and a type of data of the payload, and the reference item information indicating the priority of the nal unit, which is determined in accordance with the category of the reference picture;
a navigation pack producing unit configured to produce navigation packs each having a picture information including address information and a picture category relating to a reference picture, the picture category being determined in compliance with the importance level in respect to the reference picture;
a multiplexer configured to multiplex the navigation packs and video packs and arrange the video packs so as to follow the navigation pack to produce video object units;
a formatter configured to produce a video object including number of video object units successively arranged therein, and
a recording unit configured to record the video object in the recording area of the information storage medium.

26. A recording apparatus according to claim 25, wherein the address of the picture information corresponds to an end address of the video pack within the video object unit which contributes to produce the reference picture.

27. A recording apparatus according to claim 25, wherein the recording unit records a management information in a management area of the data recording area, the management information contains management items to manage the object, an encoded mode of a video data within the video pack is described in the management area, and the encoded mode is MPEG4 AVC.

28. A recording apparatus according to claim 25, wherein the priority of the nal unit contains one of no priority, and first, second and third priorities, and a reference picture produced by the combination of the first group of the nal units including a nal unit with the third priority described in the reference item information belongs to a picture category in the importance level.

29. A recording apparatus according to claim 28, wherein the first group of the nal units includes first, second and third nal units, the first nal units have a nal unit header in which a data type is described as a sequence parameter set and a payload of the sequence parameter set, a second nal unit has a nal unit header in which a data type is described as a picture parameter set and a payload of the picture parameter set, a third nal unit has a nal unit header in which a data type is described as a slice data and a payload of the slice data, the third priority is described in the nal unit headers of the first, second and third nal units, the reference picture produced by the combination of the first, second and third nal units belongs to the picture category in the importance level, and the picture information includes an end address of the video pack within the video object unit which contributes to produce the reference picture belonging to a picture category in the importance level and the first to appear within the video object unit.

30. A recording apparatus according to claim 29, wherein the picture information includes an end address of the video pack within the video object unit which contributes to produce the reference picture belonging to a picture category in the importance level and appears secondly within the video object unit.

31. A recording apparatus according to claim 30, wherein the picture information includes an end address of the video pack within the video object unit which contributes to the production of a reference picture belonging to a picture category in the importance level and appears thirdly within the video object unit.

32. A recording apparatus according to claim 29, wherein a reference picture produced by the combination of the first, second, and third nal units of the second priority belongs to a category in the second importance level.

33. A recording method recording a video object in a recording area of the information storage medium, comprising:
encoding an input video signal to a stream of nal units each including a nal header and a data payload, allocating the nal units in packets to produce a video elementary stream of packets and allocating the packets in packs, respectively, to produce a MPEG video stream, the nal units being classified into a first group of the nal units contributing to produce a reference picture and a second group of the nal units not contributing to produce the reference picture, the nal unit header including reference item information which describes that the nal unit belongs to the first group and contributes to produce the reference picture, and a type of data of the payload, and the reference item information indicating the priority of the nal unit, which is determined in accordance with the category of the reference picture;
producing navigation packs each having a picture information including address information and a picture category relating to a reference picture, the picture category being determined in compliance with the importance level in respect to the reference picture;
multiplexing the navigation packs and video packs and arranging the video packs so as to follow the navigation pack to produce video object units;
producing a video object including a number of video object units successively arranged therein, and
recording the video object in the recording area of the information storage medium.

34. A recording method according to claim 33, wherein the recording unit records a management information in a management area of the data recording area, the management information contains management items to manage the object, an encoded mode of a video data within the video pack is described in the management area, and the encoded mode is MPEG4 AVC.

35. A recording method according to claim 33, wherein the priority of the nal unit contains one of no priority, and first, second and third priorities, and a reference picture produced by the combination of the first group of the nal units including a nal unit with the third priority described in the reference item information belongs to a picture category in the importance level.

36. A recording method according to claim 33, wherein the first group of the nal units includes first, second and third nal units, the first nal units has a nal unit header in which a data type is described as a sequence parameter set and a payload of the sequence parameter set, a second nal unit has a nal unit header in which a data type is described as a picture parameter set and a payload of the picture parameter set, a third nal unit has a nal unit header in which a data type is described as a slice data and a payload of the slice data, the third priority is described in the nal unit headers of the first, second and third nal units, the reference picture produced by the combination of the first, second and third nal units belongs to the picture category in the importance level, and the picture information includes an end address of the video pack within the video object unit which contributes to produce the reference picture belonging to a picture category in the importance level and the first to appear within the video object unit.

37. A recording method according to claim 36, wherein the picture information includes an end address of the video pack within the video object unit which contributes to the produce the reference picture belonging to a picture category in the importance level and appears secondly within the video object unit.

38. A recording method according to claim 37, wherein an end address of the video pack within the video object unit which contributes to the production of a reference picture belonging to a picture category of the importance level and appears secondly within the video object unit is written in the picture information.

39. A recording method according to claim 38, wherein the picture information includes an end address of the video pack within the video object unit which contributes to the production of a reference picture belonging to a picture category in the importance level and appears thirdly within the video object unit.

40. A recording method according to claim 37, wherein a reference picture produced by the combination of the first, second, and third nal units of the second priority belongs to a category in the second importance level.

41. A system comprising:
a transmitter configured to transmit a video data from a server to a client; said video data including
a video object to be produced, which is recorded in the data recording area, the video object comprising a number of video object units, which are arranged consecutively,
each of the video object units comprising a pack sequence containing a navigation pack and video packs following the navigation pack,
the navigation pack having a picture information including address information and a picture category relating to a reference picture, the picture category being determined in compliance with the importance level in respect to the reference picture,
the video pack including a packet, a sequence of the packets constituting a stream of nal units which include a first group of the nal units contributing to produce the reference picture and a second group of the nal unit not contributing to produce the reference picture,
each of the nal units including a nal header and data payload, the nal header including reference item information which describes that the nal unit belongs to the first group and contributes to produce the reference picture, and a type of data of the payload, and
the reference item information indicating the priority of the nal unit, which is determined in accordance with the category of the reference picture.
